(19) United States
(12) Patent Application Publication
(10) Pub. No.: US 2015/0281187 A1
(43) Pub. Date: Oct. 1, 2015

(54) KEY TRANSMITTING METHOD AND KEY TRANSMITTING SYSTEM

(71) Applicant: FUJITSU LIMITED, Kawasaki-shi (JP)

(72) Inventors: Takao Ogura, Yokohama (JP); Tetsuya Izu, London (GB)

(21) Appl. No.: 14/640,053

(22) Filed: Mar. 6, 2015

(30) Foreign Application Priority Data
Mar. 28, 2014 (JP) 2014-069408

(51) Int. Cl. H04L 29/06; H04L 9/30; H04L 9/32; H04L 9/14

(52) U.S. Cl. CPC H04L 63/0428; H04L 63/061; H04L 9/14; H04L 9/30; H04L 9/3247; H04L 2209/24; H04L 2209/72

(57) ABSTRACT

A method for a key transmission includes: transmitting, by a user terminal, a first public key of the user terminal, an electronic signature for the first public key, and an electronic certificate signing the first public key to a first information processing apparatus via a communication apparatus that communicates with the first information processing apparatus, a second information processing apparatus, and the user terminal; and transmitting, by the first information processing apparatus, the first public key to the second information processing apparatus via a route that does not link to the communication apparatus when the first information processing apparatus determines that the first public key is authentic using the electronic signature and the electronic certificate.

### CROSS-REFERENCE TO RELATED APPLICATION

This application is based upon and claims the benefit of priority of the prior Japanese Patent Application No. 2014-069408, filed on Mar. 28, 2014, the entire contents of which are incorporated herein by reference.

### FIELD

The embodiments discussed herein are related to a method for a key transmission.

### BACKGROUND

In recent years, analysis agents have provided services for analyzing data obtained from a client over, for example, a Virtual Private Network (VPN), and for providing the client with results obtained from the analyzing. When the client requests, for each user, an analysis result on data obtained from each individual user, data to be analyzed is associated with personal information to identify the user. Accordingly, in many cases, in order to prevent personal information from leaking from data given to the analysis agent, clients perform a process of replacing the personal information with, for example, an analysis ID, which can uniquely specify an individual, and then give the processed data to the analysis agent. The analysis agent analyzes the data obtained from the client and associates an analysis result for each user with an analysis ID. In addition, the analysis agent associates the obtained analysis result with the analysis ID and then provides the client with this result. The client replaces the analysis ID associated with the analysis result obtained from the analysis agent with personal information of a user. Meanwhile, the user requests an analysis result obtained for this user from the client. Accordingly, the client provides the user who has requested an analysis result with the analysis result associated with this user.

In the meantime, when a user wishes to obtain, via the client, an analysis result obtained for the user, the analysis result is sent from the analysis agent to the client and is then sent from the client to the user. Allowing individual users to directly request the analysis result obtained for data on them from the analysis agent will improve user convenience and, in addition, decrease the processing load on a data server.

In order to access a server of the analysis agent, a user obtains an analysis ID placed in place of personal information of the user, and then makes a request for the server of the analysis agent to allow an analysis result corresponding to the obtained analysis ID to be referred to. Such a request is made to allow an analysis result corresponding to an obtained analysis ID to be referred to so that the user can request the analysis result without giving personal information of the user to the analysis server.

Meanwhile, when a user directly accesses the server of the analysis agent, information on an analysis result to be obtained by the user is desirably encrypted for the sake of security. A Diffie-Hellman (DH) scheme (e.g., Secure Sockets Layer (SSL)) is used as an encrypting method wherein public keys are exchanged, a common key is generated using one's private key and a partner's public key, and data is encrypted/decrypted using the common key. However, exchanging public keys with each other using such a method may enable a third party to secretly replace a public key in a network communication between a user and the analysis agent.

A method uses an electronic certificate for a public key to prevent the secret replacing of the public key and falsification of data. However, the method that uses a simple electronic certificate does not prevent the analysis server from identifying individual users.

Technologies described in the following documents are known.

Document 1: Japanese Laid-open Patent Publication No. 2011-166226

Document 2: Japanese Laid-open Patent Publication No. 11-191761

Document 3: Japanese Laid-open Patent Publication No. 2011-160136

### SUMMARY

According to an aspect of the embodiment, an method for a key transmission includes: transmitting, by a user terminal, a first public key of the user terminal, an electronic signature for the first public key, and an electronic certificate signing the first public key to a first information processing apparatus via a communication apparatus that communicates with the first information processing apparatus, a second information processing apparatus, and the user terminal; and transmitting, by the first information processing apparatus, the first public key to the second information processing apparatus via a route that does not link to the communication apparatus when the first information processing apparatus determines that the first public key is authentic using the electronic signature and the electronic certificate.

The object and advantages of the embodiment will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration of an information processing system in accordance with an embodiment.

FIG. 2 illustrates an exemplary key transmitting method used when a user makes a request to obtain an analysis result for the first time.

FIG. 3 illustrates an exemplary key transmitting method used when a user makes a request to obtain an analysis result for the second or later time.

FIG. 4 illustrates an exemplary system configuration.

FIG. 5 illustrates an exemplary configuration of a collection server.

FIG. 6 illustrates exemplary analysis ID tables.

FIG. 7 illustrates an exemplary configuration of an analysis server.

FIG. 8 illustrates an exemplary account table.

FIG. 9 illustrates an exemplary configuration of a communication apparatus.

FIG. 10 illustrates an exemplary ID management table.

FIG. 11 illustrates an exemplary configuration of a terminal.

FIG. 12 illustrates an example of information stored in a storage unit of a terminal.

FIG. 13 illustrates exemplary hardware configurations of a server, a communication apparatus, and a terminal.

FIG. 14 illustrates a method for generating substitution data, and an exemplary analysis result of substitution data.

FIG. 15A is a sequence diagram illustrating an exemplary communication performed when a user makes a request to obtain an analysis result for the first time in accordance with an embodiment (example 1).

FIG. 15B is a sequence diagram illustrating an exemplary communication performed when a user makes a request to obtain an analysis result for the first time in accordance with an embodiment (example 2).

FIG. 16 illustrates an example of the updating of information based on a communication between a terminal and a communication apparatus.

FIG. 17 illustrates an example of the updating of information based on authentication between a communication apparatus and an analysis server.

FIG. 18 illustrates an example of the updating of information performed when an access identifier is reported from an analysis server to a communication apparatus.

FIG. 19 illustrates an example of a registered request message.

FIG. 20 illustrates an example of the updating of information based on a communication between a communication apparatus and a collection server.

FIG. 21 illustrates an example of the updating of information performed after an access identifier is registered in a collection server.

FIG. 22A is a sequence diagram illustrating an exemplary communication performed when a user makes a request to obtain an analysis result for the second or later time in accordance with an embodiment (example 1).

FIG. 22B is a sequence diagram illustrating an exemplary communication performed when a user makes a request to obtain an analysis result for the second or later time in accordance with an embodiment (example 2).

FIG. 23 illustrates an example of the updating of information performed after an access identifier is registered in a collection server when a user makes a request to obtain an analysis result for the second or later time.

FIG. 24A is a flowchart illustrating exemplary operations of an analysis server (example 1).

FIG. 24B is a flowchart illustrating exemplary operations of an analysis server (example 2).

FIG. 25A is a flowchart illustrating exemplary operations of a communication apparatus (example 1).

FIG. 25B is a flowchart illustrating exemplary operations of a communication apparatus (example 2).

FIG. 26A is a flowchart illustrating exemplary operations of a collection server (example 1).

FIG. 26B is a flowchart illustrating exemplary operations of a collection server (example 2).

FIG. 27A is a flowchart illustrating exemplary operations of a terminal (example 1).

FIG. 27B is a flowchart illustrating exemplary operations of a terminal (example 2).

FIG. 27C is a flowchart illustrating exemplary operations of a terminal (example 3).

### DESCRIPTION OF EMBODIMENTS

Preferred embodiments of the present invention will be explained with reference to accompanying drawings.

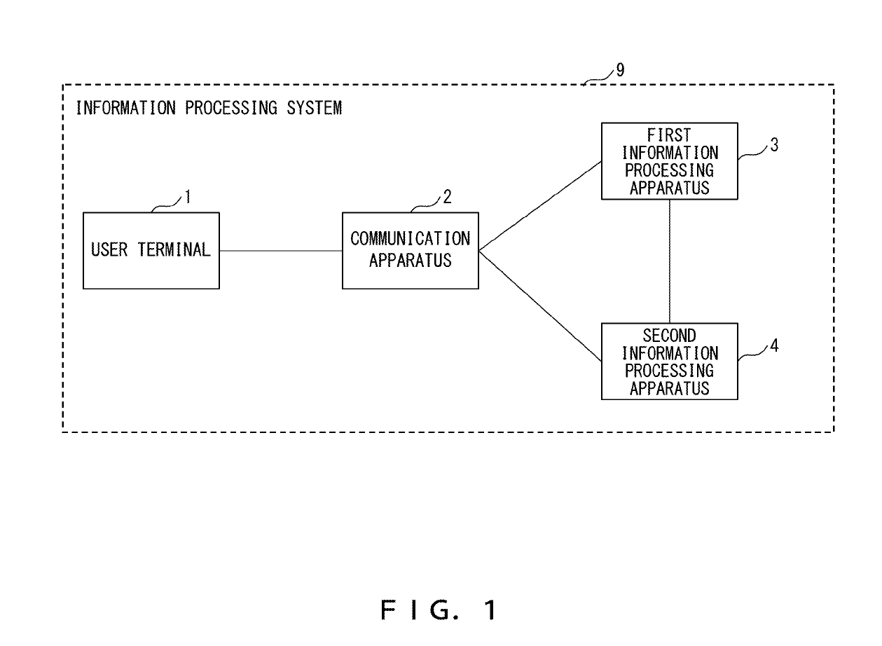

FIG. 1 illustrates an exemplary configuration of an information processing system in accordance with an embodiment. In FIG. 1, an information processing system 9 includes a user terminal 1, a first information processing apparatus 3, a second information processing apparatus 4, and a communication apparatus 2 that communicates with the first information processing apparatus 3, the second information processing apparatus 4, and the user terminal 1.

The user terminal 1 transmits a first public key thereof, an electronic signature for the first public key, and an electronic certificate signing the first public key to the first information processing apparatus 3 via the communication apparatus 2. When the first information processing apparatus 3 judges the first public key to be authentic using the electronic signature and the electronic certificate, the first information processing apparatus 3 transmits the first public key to the second information processing apparatus 4 via a route that does not link to the communication apparatus 2. The second information processing apparatus 4 transmits a second public key thereof to the user terminal 1 via the communication apparatus 2.

When the first information processing apparatus 3 judges the first public key to be authentic, the first information processing apparatus 3 transmits the first public key and a third public key thereof to the second information processing apparatus 4 via a route that does not link to the communication apparatus 2. The second information processing apparatus 4 encrypts the received third public key using a first common key generated from the received first public key and a second private key corresponding to the second public key, and transmits the second public key and the encrypted third public key to the user terminal 1 via the communication apparatus 2.

The user terminal 1 generates a second common key from a fourth private key thereof and the third public key received from the second information processing apparatus 4, and transmits the generated second common key and a fourth public key corresponding to the fourth private key to the first information processing apparatus 3 via the communication apparatus 2. The first information processing apparatus 3 inspects the authenticity of the received fourth public key using the fourth public key and a third private key corresponding to the third public key.

The first public key is associated with first identification information for identification of a user. The user terminal 1 transmits the first identification information to the first information processing apparatus 3 via the communication apparatus 2. When the first public key is judged to be authentic, the first information processing apparatus 3 transmits, to the second information processing apparatus 4, second identification information stored by the first information processing apparatus 3 and associated with the first identification information. The second information processing apparatus 4 uses the first common key to encrypt information stored by the second information processing apparatus 4 and associated with the second identification information, and transmits this encrypted information to the user terminal 1 via the communication apparatus 2.

Upon receipt of an information transmission request transmitted from the user terminal 1 via the communication apparatus 2, the second information processing apparatus 4 transmits third identification information for identification of the transmission request to the communication apparatus 2. Upon receipt of information obtained by associating the first identification information and the third identification information from the communication apparatus 2, the first information processing apparatus 3 transmits the second identification information associated with the first identification information to the second information processing apparatus 4.

When the first information processing apparatus 3 judges the first public key to be authentic, the first information processing apparatus 3 transmits inspection information indicating that the first information processing apparatus 3 has confirmed that the first public key is authentic to the second information processing apparatus 4 via a route that does not link to the communication apparatus 2. Upon receipt of the inspection information, the second information processing apparatus 4 transmits the second public key to the user terminal 1 via the communication apparatus 2.

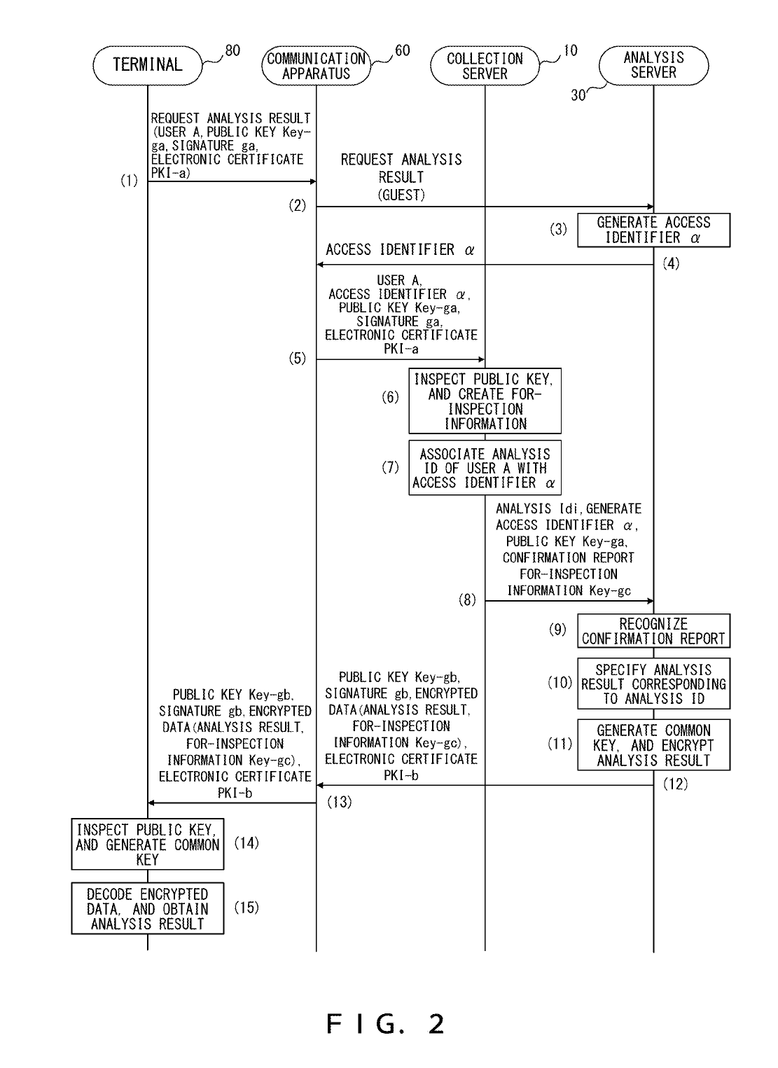

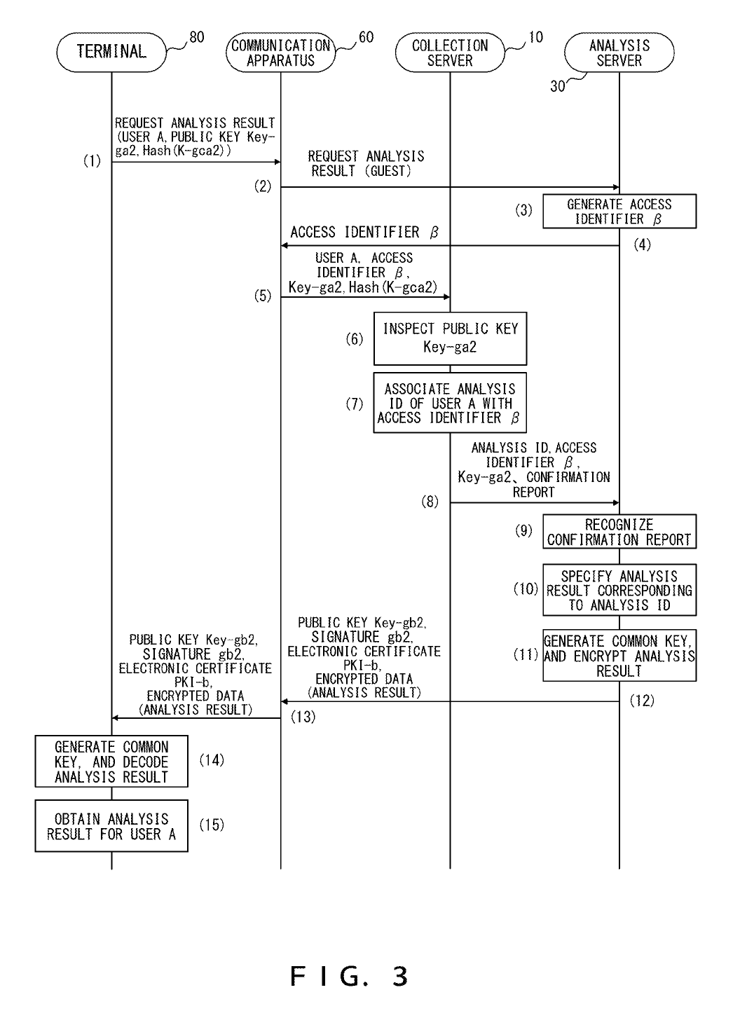

FIGS. 2 and 3 illustrate an exemplary key management method in accordance with an embodiment. FIG. 2 depicts an example in which a user makes a request to obtain an analysis result for the first time. FIG. 3 depicts an example in which a user makes a request to obtain an analysis result for the second or later time.

FIG. 2 illustrates an exemplary communication performed between a terminal 80, a communication apparatus 60, a collection server 10, and an analysis server 30.

The terminal 80 is an example of the user terminal 1. The communication apparatus 60 is an example of the communication apparatus 2. The collection server 10 is an example of the first information processing apparatus 3. The analysis server 30 is an example of the second information processing apparatus 4.

The collection server 10 stores data on each user and an analysis ID for each user. The collection server 10 extracts concealed information, i.e., information on each user to be concealed, from sensor data obtained by various sensors, and generates substitution data by replacing the concealed information with an analysis ID associated with the user. In the example of FIG. 2, concealed information related to a user A has been replaced with an analysis ID “i”. The collection server 10 transmits substitution data to the analysis server 30. The analysis server 30 analyses data included in substitution data and holds an analysis result. The analysis result for each individual user is held in association with the analysis ID of the user. In one possible example, an analysis result related to data on the user A is held by the analysis server 30 in association with the analysis ID “i”.

(1) To obtain an analysis result from the analysis server 30, the terminal 80 first makes a request for the communication apparatus 60 to transmit the analysis result. In the requesting of the analysis result, the terminal 80 transmits the identification information of the user, a public key corresponding to a private key of the user, an electronic signature signing the public key using a public key included in an electronic certificate, and the electronic certificate to the communication apparatus 60. In the example of FIG. 2, the terminal 80 transmits user identification information “A”, a public key “Key-ga” corresponding to a private key “Key-a” of the user, an electronic signature “Signature ga” of the public key “Key-ga”, and an electronic certificate “PKI-a” to the communication apparatus 60.

(2) Upon receipt of a request for an analysis result from the terminal 80, the communication apparatus 60 accesses the analysis server 30 using a guest ID and requests the analysis result. The guest ID may be a unique ID assigned to a group to which the user belongs.

(3) Upon receipt of the request for the analysis result from the communication apparatus 60, the analysis server 30 generates an access identifier corresponding to the request. Note that the access identifier is a unique identifier assigned to the request for the analysis result. In the example of FIG. 2, the analysis server 30 generates an access identifier “α”.

(4) The analysis server 30 transmits an access identifier to the communication apparatus 60. In the example of FIG. 2, the analysis server 30 transmits the access identifier “α” to the communication apparatus 60.

(5) The communication apparatus 60 transmits the access identifier received from the analysis server 30 to the collection server 10 together with the identification information of the user, the public key, the electronic signature, and the electronic certificate, all received in procedure (1) described above. In the example of FIG. 2, a combination of the access identifier “α” for identification of the user, the user identification information “A”, the public key “Key-ga”, the electronic signature “Signature ga”, and the electronic certificate “PKI-a” is reported from the communication apparatus 60 to the collection server 10.

(6) The collection server 10 inspects the authenticity of the received public key using the public key, electronic signature, and electronic certificate received from the communication apparatus 60. When the collection server 10 judges the received public key to be authentic, the collection server 10 generates for-inspection information. For-inspection information is, in particular, a public key corresponding to a private key of the collection server 10. In the example of FIG. 2, the collection server 10 receives a combination of the access identifier “α”, the user identification information “A”, the public key “Key-ga”, the electronic signature “Signature ga”, and the electronic certificate “PKI-a” from the communication apparatus 60, and inspects the authenticity of the public key “Key-ga”. When the collection server 10 judges the public key “Key-ga” to be authentic, the collection server 10 generates a public key “Key-gc” corresponding to a private key “Key-c” of the collection server 10 as for-inspection information.

(7) The collection server 10 associates an access identifier and an analysis ID using a combination of received user identification information and access identifier. In the example of FIG. 2, the collection server 10 recognizes from information received from the communication apparatus 60 that the access identifier “α” has been assigned to the user “A”. Accordingly, the collection server 10 associates the access identifier “α” with the analysis ID “i” associated with the user “A”.

(8) The collection server 10 transmits to the analysis server 30 a combination of the access identifier received in procedure (5) described above, the analysis ID associated with the access identifier in procedure (7) described above, the public key received in procedure (5) described above, the for-inspection information generated in procedure (6) described above, and a confirmation report. The confirmation report is a report (inspection information) indicating that the collection server 10 has confirmed that the public key of the user is authentic. The transmitted information is received by the analysis server 30 via a route that does not link to the communication apparatus 60. In the example of FIG. 2, a combination of the access identifier “α”, the analysis ID “i”, the public key “Key-ga”, the for-inspection information “Key-gc” is transmitted from the collection server 10 to the analysis server 30.

(9) Upon receipt of the information transmitted from the collection server 10 in procedure (8) described above, the analysis server 30 checks that the received information includes a confirmation report.

(10) For the analysis result associated with the analysis ID reported from the collection server 10, the analysis server 30 determines that a request to transmit the analysis result has been made. That is, the analysis server 30 recognizes that the analysis result requested in procedure (2) described above is an analysis result associated with the analysis ID reported from the collection server 10. In the example of FIG. 2, the analysis server 30 determines that the analysis result associated with the analysis ID “i” has been requested by the communication apparatus 60.

(11) Next, the analysis server 30 generates a common key from the public key of the user received in procedure (9) described above and the private key of the analysis server 30. The analysis server 30 uses the generated common key to encrypt for-inspection information and the analysis result associated with the received analysis ID. In the example of FIG. 2, the analysis server 30 generates a common key “K-gab” from the received public key “Key-ga” and the private key “Key-b” of the analysis server 30. The analysis server 30 uses the common key “K-gab” to encrypt the for-inspection information “Key-gc” and the analysis result associated with the analysis ID “i”.

(12) The analysis server 30 transmits to the communication apparatus 60 a public key corresponding to the private key of the analysis server 30, an electronic signature signing the public key using a public key included in an electronic certificate, the electronic certificate, and the encrypted for-inspection information and analysis result associated with the analysis ID. “Signing data” herein means generating an electronic signature that is signature information for guaranteeing the validity of data. In the example of FIG. 2, the analysis server 30 transmits to the communication apparatus 60 a public key “Key-gb” of the analysis server 30, an electronic signature “Signature gb”, the electronic certificate “PKI-b”, and the encrypted for-inspection information “Key-gc” and analysis result associated with the analysis ID “i”.

(13) The communication apparatus 60 transfers to the terminal 80 the information received from the analysis server 30.

(14) The terminal 80 inspects the authenticity of the received public key of the analysis server 30 using the received electronic signature and electronic certificate. When the terminal 80 judges the public key of the analysis server 30 to be authentic, the terminal 80 generates a common key from the public key of the analysis server 30 and the private key of the terminal 80. In the example of FIG. 2, the terminal 80 generates a common key “K-gba” from the public key “Key-gb” of the analysis server 30 and the private key “Key-a” of the terminal 80.

(15) The terminal 80 uses the generated common key to decrypt the encrypted for-inspection information and analysis result associated with the analysis ID. As a result of the decrypting, the terminal 80 obtains the analysis result and for-inspection information for the user and records this for-inspection information. In the example of FIG. 2, the terminal 80 uses the generated common key “K-gba” to decrypt the encrypted for-inspection information “Key-gc” and analysis result associated with the analysis ID “i”. The terminal 80 records the for-inspection information “Key-gc” and obtains the analysis result associated with the analysis ID “i”.

In the key exchanging method described with reference to FIG. 2, the collection server 10 inspects, in procedure (6) of FIG. 2, the authenticity of the public key corresponding to the private key of the user using an electronic signature and an electronic certificate. Hence, when the public key of the user is secretly replaced in a communication from the terminal 80 to the collection server 10, the collection server 10 detects that the public key has been replaced.

When the collection server 10 confirms that the received public key is authentic, the collection server 10 transmits, in procedure (8), a confirmation report indicating that the collection server 10 has confirmed that the public key of the user is authentic. Then, the collection server 10 transmits the public key of the user to the analysis server 30 together with the confirmation report via a route that does not link to the communication apparatus 60 and the analysis server 30 checks in procedure (9) that the confirmation report has been received. Hence, without recognizing the identification information of the user, the analysis server 30 checks that the received public key of the user has not been secretly replaced by the communication apparatus 60. Data to be concealed, e.g., personal information of a user, is not transmitted to the analysis server 30, and hence, even when the analysis server 30 is managed by a third party unrelated to the user, there is no leakage of, for example, personal information.

In procedure (11), the analysis result is transmitted to the terminal 80 after being encrypted using the common key generated from the public key of the user and the private key of the analysis server 30. Accordingly, information on the analysis result is concealed from the communication apparatus 60.

In procedure (14), the terminal 80 uses an electronic signature and an electronic certificate so as to inspect the authenticity of a public key corresponding to the private key of the collection server 10. Hence, when the public key of the collection server 10 is secretly replaced in a communication from the collection server 10 to the terminal 80, the terminal 80 detects that the public key has been replaced.

With reference to FIG. 3, the following will describe an example in which a user makes a request to obtain an analysis result for the second or later time.

(1) The terminal 80 makes a request for the communication apparatus 60 to transmit an analysis result. In the requesting of the analysis result, the terminal 80 first generates a common key from a public key corresponding to a private key of a user and for-inspection information received from the analysis server 30 when the previous request was made. Each of the public keys of the user used for the second and later requests is different from the private keys used in the previously performed processes of requesting an analysis result. Next, the terminal 80 calculates a hash value of the generated common key. A conventional hash function may be used to calculate a hash value. The terminal 80 transmits identification information of the user, the public key corresponding to the private key of the user, and the calculated hash value to the communication apparatus 60. In the example of FIG. 3, the terminal 80 generates a common key “K-gca2” from the private key “Key-a2” of the user and transmits the identification information “A” of the user, a public key “Key-ga2” corresponding to the private key “Key-a2” of the user, and a hash value “Hash(K-gca2)” to the communication apparatus 60.

(2) Upon receipt of the request for an analysis result from the terminal 80, the communication apparatus 60 accesses the analysis server 30 using a guest ID and requests the analysis result. The guest ID may be a unique ID assigned to a group to which the user belongs.

(3) Upon receipt of the request for the analysis result from the communication apparatus 60, the analysis server 30 generates an access identifier corresponding to the request. Note that the access identifier is a unique identifier assigned to the request for the analysis result. In the example of FIG. 3, the analysis server 30 generates an access identifier “β”.

(4) The analysis server 30 transmits an access identifier to the communication apparatus 60. In the example of FIG. 3, the analysis server 30 transmits the access identifier “β” to the communication apparatus 60.

(5) The communication apparatus 60 transmits the access identifier received from the analysis server 30 to the collection server 10 together with the identification information of the user, the public key, and the hash value, all received in procedure (1) described above. In the example of FIG. 3, a combination of the access identifier “13” for identification of the user, the user identification information “A”, the public key “Key-ga”, and the hash value “Hash(K-gca2)” is reported from the communication apparatus 60 to the collection server 10.

(6) The collection server 10 inspects the authenticity of the received public key using the hash value received from the communication apparatus 60. That is, the collection server 10 first generates a common key using the received public key and the private key of the collection server 10. Then, the collection server 10 calculates a hash value of the generated common key. Assume that the hash function used to calculate the hash value is the same as the hash function used by the terminal 80 to calculate a hash value in procedure (1), i.e., settings are made in advance such that the same hash function will be used. The collection server 10 determines whether the calculated hash value is the same as the received hash value. When the collection server 10 determines that the calculated hash value is the same as the received hash value, the collection server 10 determines that the received public key of the user is authentic. In the example of FIG. 3, the collection server 10 first receives a combination of the access identifier “β”, the user identification information “A”, the public key “Key-ga2”, and the hash value “Hash(K-gca2)”. Then, the collection server 10 generates a common key “Hash(K-ga2c)” using the public key “Key-ga2” and a private key “c” of the collection server 10. Subsequently, the collection server 10 calculates a hash value “Hash(K-ga2c)” of the generated common key “K-ga2C”. The collection server 10 determines the authenticity of the public key “Key-ga2” by determining whether the calculated hash value “Hash(K-ga2c)” is equal to the received hash value “Hash(K-gca2)”.

(7) Using a combination of a received access identifier and user identification information, the collection server 10 associates the access identifier and an analysis ID. In the example of FIG. 3, the collection server recognizes from the information received from the communication apparatus 60 that the access identifier “13” has been assigned to the user “A”. Accordingly, the collection server 10 associates the access identifier “β” with the analysis ID “i” associated with the user “A”.

(8) The collection server 10 transmits to the analysis server 30 a combination of the access identifier received in procedure (5) described above, the analysis ID associated with the access identifier in procedure (7) described above, the public key received in procedure (5) described above, and a confirmation report. The transmitted information is received by the analysis server 30 via a route that does not link to the communication apparatus 60. In the example of FIG. 3, a combination of the access identifier “β”, the analysis ID “i”, the public key “Key-ga2”, and the confirmation report is transmitted from the collection server 10 to the analysis server 30.

(9) Upon receipt of the information transmitted from the collection server 10 in procedure (8) described above, the analysis server 30 checks that the received information includes a confirmation report.

(10) The analysis server 30 determines that a request to transmit the analysis result associated with the analysis ID reported from the collection server 10 has been made. That is, the analysis server 30 recognizes that the analysis result requested in procedure (2) described above is associated with the analysis ID reported from the collection server 10. In the example of FIG. 3, the analysis server 30 determines that the analysis result associated with the analysis ID “i” has been requested by the communication apparatus 60.

(11) Next, the analysis server 30 generates a common key from the public key of the user received in procedure (9) described above and the private key of the analysis server 30. Each of the private keys of the analysis server 30 used in the second and later requests is different from the private keys used in the previously performed processes of requesting an analysis result. The analysis server 30 uses the generated common key to encrypt the analysis result associated with the received analysis ID. In the example of FIG. 3, the analysis server 30 generates a common key “K-ga2b2” from the received public key “Key-ga2” and the private key “Key-b2” of the analysis server 30. The analysis server 30 uses the common key “K-ga2b2” to encrypt the analysis result associated with the analysis ID “i”.

(12) The analysis server 30 transmits to the communication apparatus 60 the private key of the analysis server 30, an electronic signature signing the public key using a public key included in an electronic certificate, the electronic certificate, and the encrypted analysis result associated with the analysis ID. In the example of FIG. 3, the analysis server 30 transmits to the communication apparatus 60 a public key “Key-gb2” of the analysis server 30, an electronic signature “Signature gb2”, the electronic certificate “PKI-b”, and the encrypted analysis result associated with the analysis ID “i”.

(13) The communication apparatus 60 transfers to the terminal 80 the information received from the analysis server 30.

(14) The terminal 80 inspects the authenticity of the received public key of the analysis server 30 using the received electronic signature and electronic certificate. When the terminal 80 judges the public key of the analysis server 30 to be authentic, the terminal 80 generates a common key from the public key of the analysis server 30 and the private key of the terminal 80. In the example of FIG. 3, the terminal 80 generates a common key “K-gb2a2” from the public key “Key-gb2” of the analysis server 30 and the private key “Key-a2” of the terminal 80.

(15) The terminal 80 uses the generated common key to decrypt the encrypted analysis result associated with the analysis ID. As a result of the decrypting, the terminal 80 obtains an analysis result for the user. In the example of FIG. 3, the terminal 80 uses the generated common key “K-gb2a2” to decrypt the encrypted analysis result associated with the analysis ID “i”, and, as a result, obtains an analysis result associated with the analysis ID “i”.

In the key exchanging method described with reference to FIG. 3, the collection server 10 inspects, in procedure (6) of FIG. 3, the authenticity of the public key of the user using the hash value of a common key. That is, in the process of obtaining an analysis result performed for the second or later time, an electronic certificate of a public key is not transmitted or received between the communication apparatus 60 and the collection server 10. In comparison with key information (several tens of bytes), an electronic certificate typically has a large amount of information (several kilobytes), and the present embodiment, i.e., an embodiment in which such an electronic certificate is not transmitted or received, limits the cost for channels when connections are established using, for example, dedicated lines. In addition, the number of times the collection server 10 sends a query to a certifying body so as to inspect an electronic certificate and the number of times the collection server 10 makes a check as to whether an electronic certificate has become invalid may be decreased, thereby suppressing the load applied to the collection server 10.

For ease of description, the examples of FIGS. 2 and 3 have been described with reference to a situation in which a personal user uses the communication apparatus 60, but the communication apparatus 60 may be an apparatus accessed by a plurality of users, e.g., a server that provides portal sites.

<System Configuration and Apparatus Configuration>

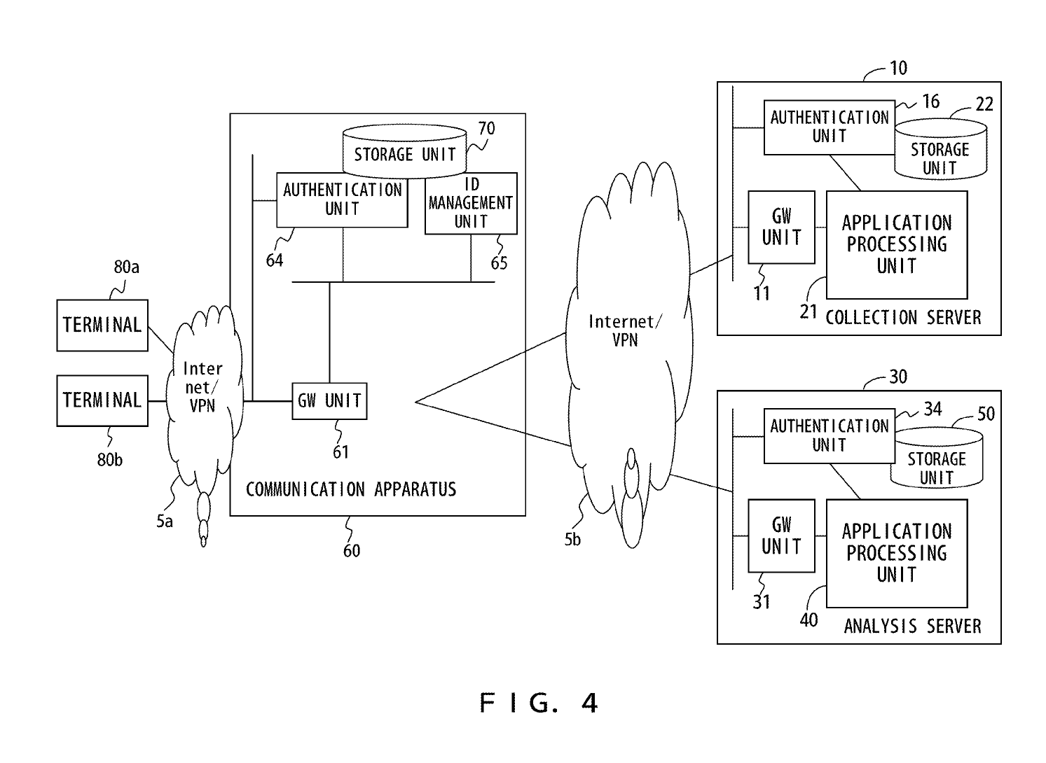

FIG. 4 illustrates an exemplary system configuration. The following descriptions will be given with reference to an exemplary situation in which the communication apparatus 60 is accessed by a plurality of users. Each user uses a terminal 80 (80a, 80b) to access the communication apparatus 60 over an Internet 5a. The communication apparatus 60 performs a proxy authentication process for the collection server 10 and the analysis server 30 as a proxy for the individual terminals 80 of the users. The communication apparatus 60 communicates with the collection server 10 and the analysis server 30 over an Internet 5b. The apparatus configurations of the collection server 10, the analysis server 30, the communication apparatus 60, and the terminal 80 will be described hereinafter. Communications performed over the Internet 5a and Internet 5b properly use a Virtual Private Network (VPN).

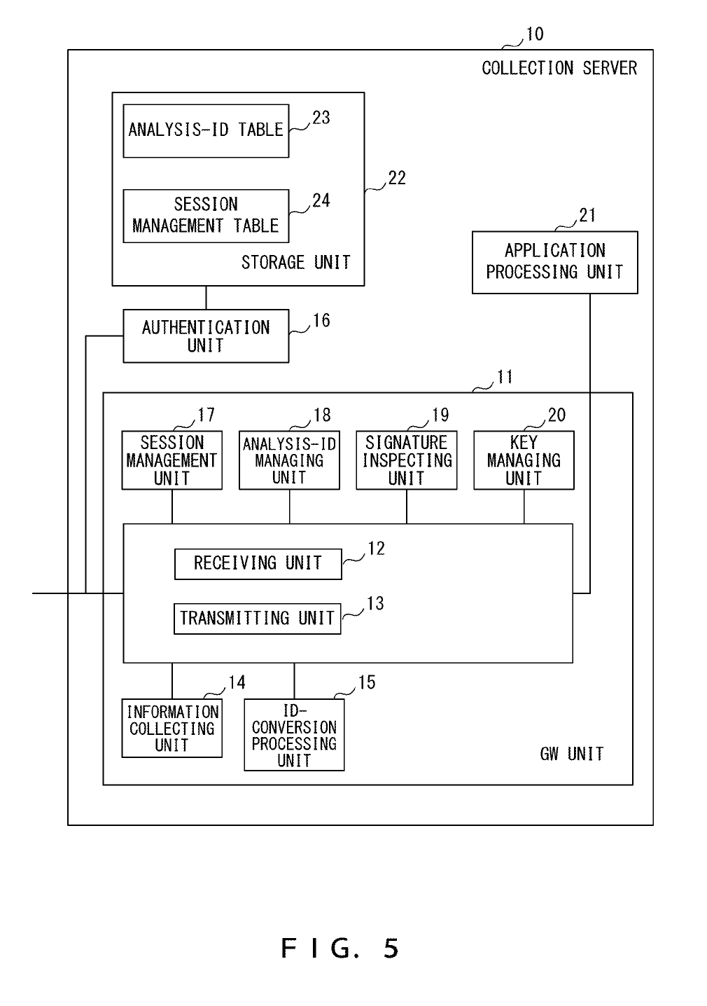

FIG. 5 illustrates an exemplary configuration of the collection server 10. The collection server 10 includes a gateway (GW) unit 11, an authentication unit 16, an application processing unit 21, and a storage unit 22. The gateway unit 11 includes a receiving unit 12, a transmitting unit 13, an information collecting unit 14, an ID-conversion processing unit 15, a session managing unit 17, an analysis-ID managing unit 18, a signature inspecting unit 19, and a key managing unit 20. The storage unit 22 holds an analysis ID table 23 and a session management table 24 and further stores various types of data to be used by, for example, the gateway unit 11, the authentication unit 16, and the application processing unit 21.

The receiving unit 12 receives data from the communication apparatus 60 and the analysis server 30 over the Internet 5b. In accordance with the type of the received data, the receiving unit 12 distributes the data to, for example, the authentication unit 16, the information collecting unit 14, the session managing unit 17, the analysis-ID managing unit 18, and the application processing unit 21. The transmitting unit 13 transmits data input from, for example, the authentication unit 16, the ID-conversion processing unit 15, the session managing unit 17, the analysis-ID managing unit 18, and the application processing unit 21. The transmitting unit 13 transmits data to the analysis server 30 and the communication apparatus 60 over the Internet 5b.

The information collecting unit 14 collects various types of data. The collected data may be, for example, data measured by various sensors connected over the Internet 5b. The collected data is transmitted to the ID-conversion processing unit 15.

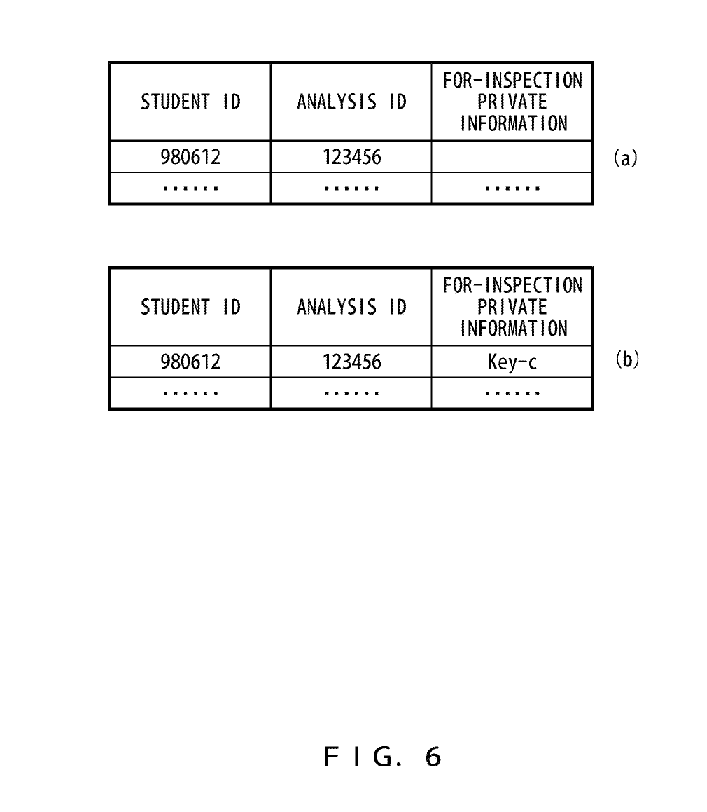

The ID-conversion processing unit 15 receives data from the information collecting unit 14. The ID-conversion processing unit 15 extracts concealed information from the received data and generates substitution data by replacing the concealed information using an analysis ID associated with a user. The ID-conversion processing unit 15 refers to the analysis ID table 23 to determine an analysis ID to be used to generate substitution data. The analysis ID table 23 associates information for unique identification of the user, an analysis ID to be assigned to data on the user in generating substitution data, and for-inspection private information used to inspect the authenticity of a public key. FIG. 6 illustrates examples of the analysis ID table 23. FIG. 6 depicts an example in which users are students and a group is a school, and the student ID of each user is associated with an analysis ID. In the table of (a) of FIG. 6, although information is not stored in “FOR-INSPECTION PRIVATE INFORMATION”, the for-inspection private information generated by the key managing unit 20 in an initial login is recorded in association with a student ID. The table of (b) of FIG. 6 indicates an example of the analysis ID table 23 with for-inspection private information recorded therein, and this will be described hereinafter. The ID-conversion processing unit 15 transmits generated substitution data to the analysis server 30 via the transmitting unit 13.

The authentication unit 16 performs an authentication process on a user who has accessed the collection server 10, and determines whether the user is authorized to use the collection server 10. For each individual user authorized to access the collection server 10, the authentication unit 16 preliminarily stores information on a combination of an account and a password. An account assigned to each individual user will hereinafter be referred to as a “user account”.

When the authentication performed by the authentication unit 16 succeeds, the session managing unit 17 generates a session ID. The session managing unit 17 transmits the session ID via the transmitting unit 13 to the communication apparatus 60 for which authentication has succeeded. In addition, the session managing unit 17 generates the session management table 24 by associating each session with information on a user performing a communication using the session. Examples of the session management table 24 and exemplary methods for using the same will be described hereinafter.

When a change is made to the analysis ID table 23, the analysis-ID managing unit 18 modifies the analysis ID table 23. The analysis ID table 23 may be changed in accordance with a contract between the administrator of the collection server 10 and a user. The analysis ID table 23 is modified when an operator transmits a message reporting details of the change in the analysis ID table 23 from the communication apparatus 60 used to control the collection server 10 to the analysis-ID managing unit 18.

The signature inspecting unit 19 inspects the authenticity of a public key received from the terminal 80 via the communication apparatus 60 using signature information of the public key and an electronic certificate received together with the signature information. In particular, in one possible example, the signature inspecting unit 19 inquires with the issuer of the electronic certificate (e.g., certifying body) as to whether the owner of the electronic certificate is authentic, for example, whether the electronic certificate has become invalid, and whether the expiration date of the electronic certificate has been exceeded. In another possible example, the signature inspecting unit 19 compares a value calculated using the received public key and a public key included in the electronic certificate with the value of the received signature information, and checks whether these values are identical with each other. When the authenticity of the public key of the user received from the terminal 80 is confirmed, the public key of the user is transmitted to the analysis server 30 via a route that does not link to the communication apparatus 60. In this case, a confirmation report indicating that the collection server 10 has determined that the public key of the user is authentic is also transmitted together with the public key of the user.

When the signature inspecting unit 19 confirms the authenticity of the received public key of the user, the key managing unit 20 generates a private key of the collection server 10 as for-inspection private information and further generates a public key corresponding to the generated private key as for-inspection information. The key managing unit 20 stores the generated for-inspection private information in the analysis ID table 23 in association with a student ID. For-inspection information is transmitted together with the public key of the user to the analysis server 30 via a route that does not link to the communication apparatus 60. A used key generation algorithm is such that the common key generated using the public key of the user and the private key of the collection server 10 becomes identical with the common key generated using the public key of the collection server 10 and the private key of the terminal 80. The key generation algorithm is, for example, a Diffie-Hellman scheme.

The application processing unit 21 performs an application-based process on data input via the receiving unit 12.

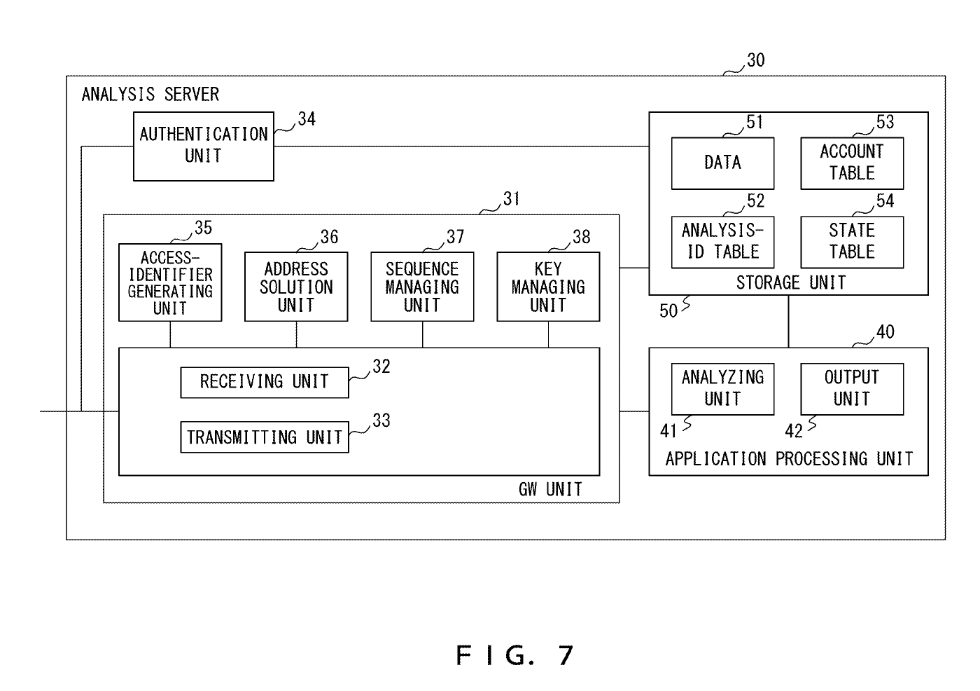

FIG. 7 illustrates an exemplary configuration of the analysis server 30. The analysis server 30 includes a gateway unit 31, an authentication unit 34, an application processing unit 40, and a storage unit 50. The gateway unit 31 includes a receiving unit 32, a transmitting unit 33, an access-identifier generating unit 35, an address solution unit 36, a sequence managing unit 37, and a key managing unit 38.

The receiving unit 32 receives data from the communication apparatus 60 and the collection server 10 over the Internet 5b. In accordance with the type of the received data, the receiving unit 32 distributes the data to, for example, the authentication unit 34, the access-identifier generating unit 35, the address solution unit 36, the sequence managing unit 37, the key managing unit 38, and the application processing unit 40. The transmitting unit 33 transmits data input from, for example, the authentication unit 34, the access-identifier generating unit 35, the address solution unit 36, the sequence managing unit 37, the key managing unit 38, and the application processing unit 40. The transmitting unit 13 transmits data to the collection server 10 and the communication apparatus 60 over the Internet 5b.

The authentication unit 34 performs an authentication process on a user who has accessed the analysis server 30, and determines whether the user is authorized to use the analysis server 30. Each user uses a guest account so as to cause the communication apparatus 60 to make a request for the analysis server 30 to perform authentication. Alternatively, each user makes a request to perform authentication using an account assigned to a group to which the user belongs. In this case, for a group authorized to access the analysis server 30, the authentication unit 34 preliminarily stores information on a combination of an account and a password. The account of each group stored in the authentication unit 34 will hereinafter be referred to as a “group account”.

When the authentication performed by the authentication unit 34 succeeds, the access-identifier generating unit 35 generates and transmits a session ID via the transmitting unit 33 to an apparatus for which the authentication has succeeded. In addition, when the analysis server 30 receives a request message for requesting an analysis result, the access-identifier generating unit 35 generates an access identifier. The access-identifier generating unit 35 records the access identifier in an analysis ID table 52 within the storage unit 50 in association with a session ID.

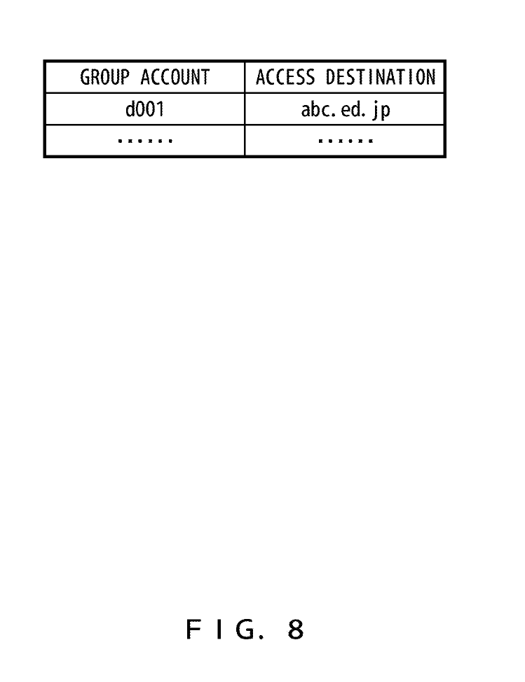

The address solution unit 36 uses an account table 53. The account table 53 associates a group account with identification information of the collection server 10 that holds data on a group identified by the group account. Assume that, when an analysis service is contracted between the collection server 10 and an analysis agent, the account table 53 is generated before the analysis service is provided. FIG. 8 depicts an example of the account table 53. In the example of FIG. 8, a URL (Uniform Resource Locator) used by a user to access the collection server 10 is used as identification information. Identification information is not limited to a URL, but may be, for example, an IP address (Internet Protocol address) assigned to the collection server 10.

For each access identifier, the sequence managing unit 37 determines whether the access identifier has been registered in the collection server 10, and records the result of the determination in a state table 54. An example of the state table 54 will be described hereinafter.

The key managing unit 38 receives a public key of the user from the collection server 10 via a route that does not link to the communication apparatus 60. The key managing unit 38 creates a private key of the analysis server 30 and a public key corresponding to the private key. The key managing unit 38 signs the created public key of the analysis server 30 using a public key of an electronic certificate registered in advance, and generates signature information (electronic signature). The electronic certificate includes the public key used to generate signature information, and owner information of the public key. The public key included in the electronic certificate is different from the public key generated by the key managing unit 38. The key managing unit 38 further generates a common key using the received public key of the user and the generated private key of the analysis server 30. A used key generation algorithm is such that the common key generated from the public key of the user and the private key of the analysis server 30 becomes identical with the common key generated from the public key of the analysis server 30 and the private key of the terminal 80. The key generation algorithm is, for example, a Diffie-Hellman scheme. After generating the common key, the key managing unit 38 records the generated common key, the public key of the user, the public key of the analysis server 30, and an analysis ID in the analysis ID table 52 in association with each other.

The application processing unit 40 includes an analyzing unit 41 and an output unit 42. The analyzing unit 41 analyzes substitution data received from the collection server 10 and generates an analysis result. The analysis result is stored as data 51.

When an analysis ID corresponding to a user for whom a request to output an analysis result has been made using a request message is reported to the analysis server 30, the output unit 42 obtains an analysis result associated with the reported analysis ID from the storage unit 50, and outputs this analysis result to the key managing unit 38. The key managing unit 38 generates cryptographic data by encrypting for-inspection information and information on the analysis result input from the output unit 42 using the generated common key. The key managing unit 38 transmits the generated cryptographic data, the public key of the analysis server 30, the signature information signing the public key using the electronic certificate of the analysis server 30, and the electronic certificate of the analysis server 30 to the terminal 80 via the communication apparatus 60.

The storage unit 50 holds data 51, the analysis ID table 52, the account table 53, and the state table 54. Data 51 includes an analysis result. The storage unit 50 further stores data obtained through processes performed by the gateway unit 31, the authentication unit 34, and the application processing unit 40, and data used in processes performed by the gateway unit 31, the authentication unit 34, and the application processing unit 40.

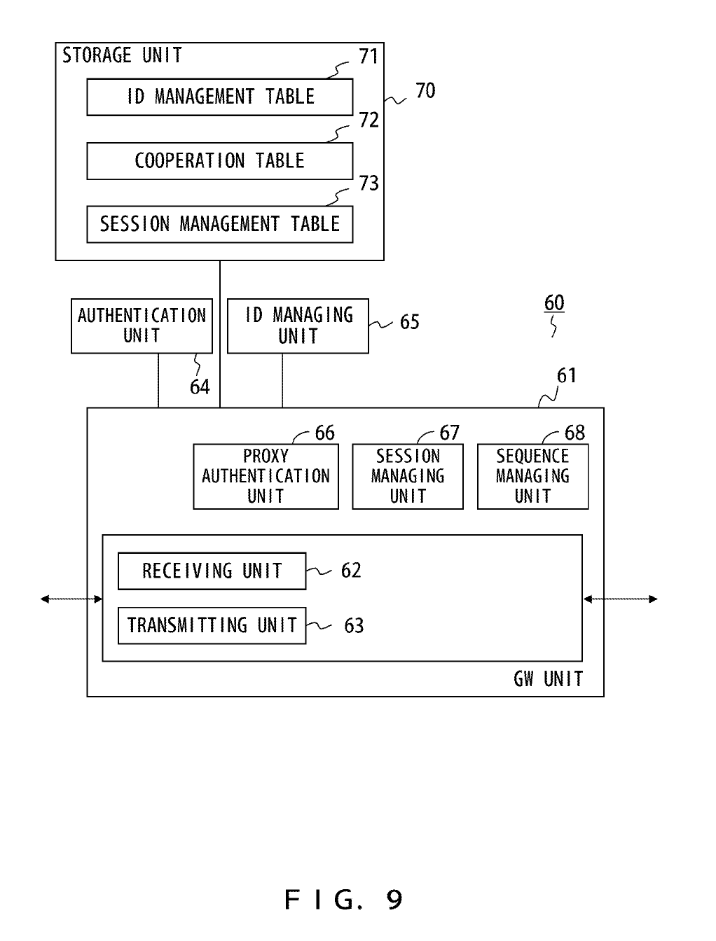

FIG. 9 illustrates an exemplary configuration of the communication apparatus 60. The communication apparatus 60 includes a gateway unit 61, an authentication unit 64, an ID managing unit 65, and a storage unit 70. The gateway unit 61 includes a receiving unit 62, a transmitting unit 63, a proxy authentication unit 66, a session managing unit 67, and a sequence managing unit 68.

The storage unit 70 holds an ID management table 71, a cooperation table 72, and a session management table 73, and further stores data generated though processes performed by the gateway unit 61, the transmitting unit 63, and the ID managing unit 65.

The receiving unit 62 receives data from the terminal 80 over the Internet 5a, and further receives data from the collection server 10 and the analysis server 30 over the Internet 5b. In accordance with the type of the received data, the receiving unit 62 distributes the data to the authentication unit 64, the ID managing unit 65, the proxy authentication unit 66, the session managing unit 67, and the sequence managing unit 68. The transmitting unit 63 transmits data to the terminal 80 over the Internet 5a and further transmits data to the collection server 10 and the analysis server 30 over the Internet 5b.

The authentication unit 64 performs an authentication process on the terminal 80 that has accessed the communication apparatus 60, and determines whether the user who has attempted to gain access using the terminal 80 is authorized to use the communication apparatus 60. In one possible example, the authentication unit 64 receives an electronic certificate from the terminal 80 and performs authentication of the terminal 80 using information on the owner of the electronic certificate.

The session managing unit 67 generates a session ID for the terminal 80 that has been successfully authenticated. The session managing unit 67 also manages information on session IDs used in communications between the communication apparatus 60 and the analysis server 30 and between the communication apparatus 60 and the collection server 10. To easily distinguish session IDs, a session ID used in a communication between the terminal 80 and the communication apparatus 60 and a session ID used in a communication between the communication apparatus 60 and the analysis server 30 will hereinafter be referred to as a “first session ID” and a “second session ID”, respectively. In addition, a session ID used in a communication between the communication apparatus 60 and the collection server 10 will hereinafter be referred to as a “third session ID”.

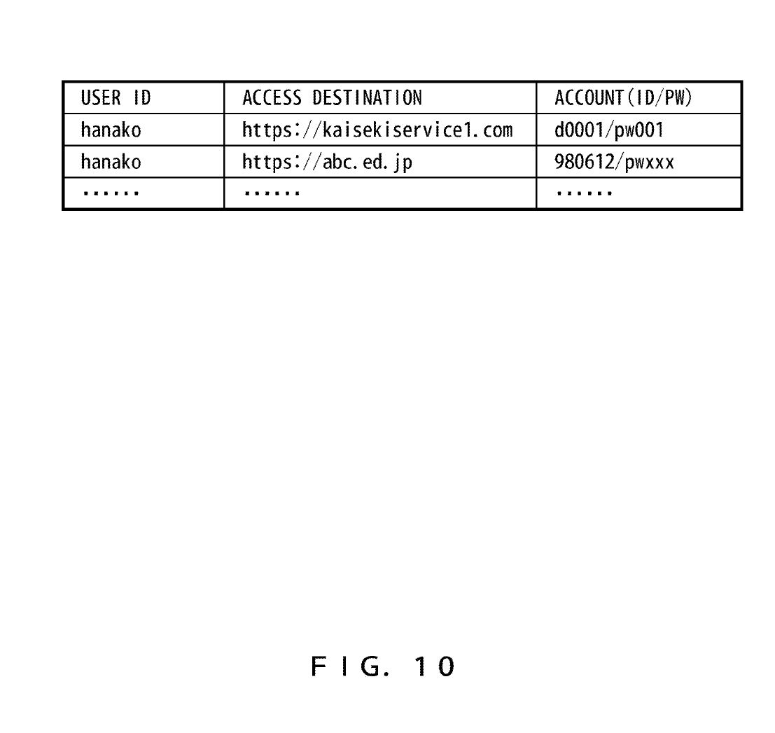

The ID managing unit 65 performs a process of updating the ID management table 71. The ID management table 71 holds information on a user for whom the communication apparatus 60 performs proxy authentication. The ID management table 71 is generated or updated when a contract is made between the user and an agent that provides services according to the communication apparatus 60. Information for identifying an access destination for each user and information to be used for authentication at the access destination are recorded in the ID management table 71 in association with each other. FIG. 10 depicts an example of the ID management table 71. In the example of FIG. 10, the URLs of access destinations at which the communication apparatus 60 performs proxy authentication, and accounts and passwords to be used for authentication at the access destinations, are recorded in association with a user ID.

The proxy authentication unit 66 performs proxy authentication using information from the ID management table 71.

For each user, the session managing unit 67 manages values corresponding to a first session ID, a second session ID, and a third session ID, and information on a communication partner in a communication that uses the second session ID and/or the third session ID. The session managing unit 67 stores, in the cooperation table 72, and manages a received public key of the user, an electronic certificate, and a hash value of the common key, i.e., signature information of the public key.

The sequence managing unit 68 specifies a communication situation specified by a session ID in association with the session ID, and records the specified communication situation in the session management table 73.

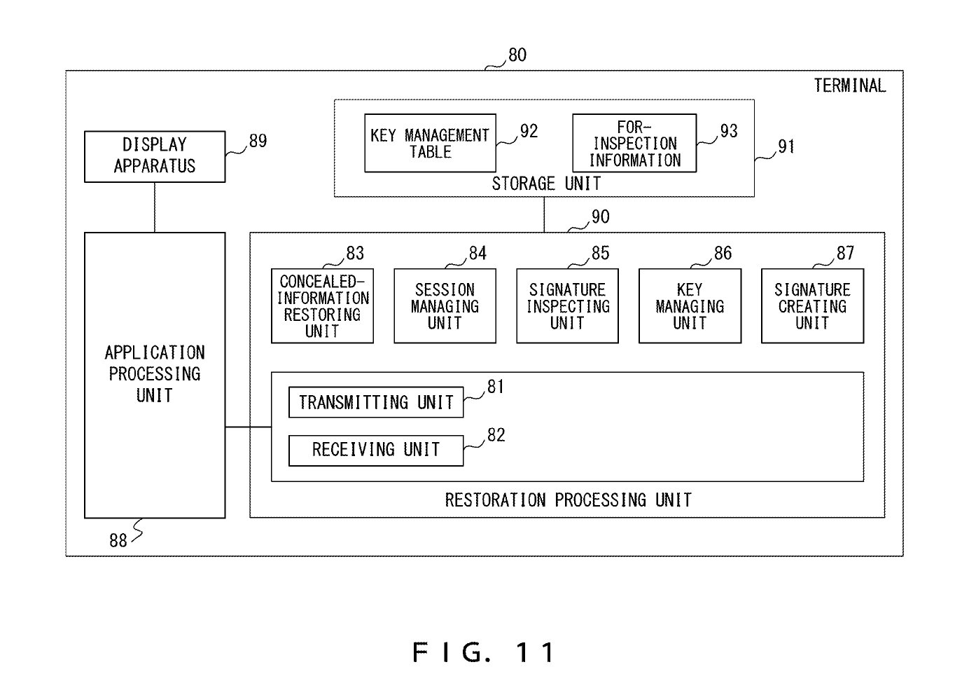

FIG. 11 depicts an exemplary configuration of the terminal 80. The terminal 80 includes an application processing unit 88, a display apparatus 89, a restoration processing unit 90, and a storage unit 91. The restoration processing unit 90 includes a transmitting unit 81, a receiving unit 82, a concealed-information restoring unit 83, a session managing unit 84, a signature inspecting unit 85, a key managing unit 86, and a signature creating unit 87.

The transmitting unit 81 transmits data to the communication apparatus 60 over the Internet 5a.

The receiving unit 82 receives data from the communication apparatus 60 over the Internet 5a and, in accordance with the type of the received data, distributes the data to the concealed-information restoring unit 83, the session managing unit 84, the signature inspecting unit 85, the key managing unit 86, and the signature creating unit 87.

The concealed-information restoring unit 83 performs an encrypting process for encrypting data to be transmitted to the communication apparatus 60. In addition, when data received from the communication apparatus 60 via the receiving unit 82 has been encrypted, the concealed-information restoring unit 83 decrypts this received data. When the decrypted cryptographic data includes for-inspection information, the concealed-information restoring unit 83 records the for-inspection information in the storage unit 91 as for-inspection information 93.

The session managing unit 84 holds and properly updates session information to be used in a communication with the communication apparatus 60.

Using a public key of an electronic certificate received together with signature information of a public key (of the analysis server 30) received from the analysis server via the communication apparatus 60, the signature inspecting unit 85 inspects the authenticity of the public key. In particular, in one possible example, the signature inspecting unit 85 inquires with the issuer of the electronic certificate (e.g., certifying body) as to confirm, for example, whether the owner of the electronic certificate is authentic, whether the electronic certificate has become invalid, and whether the expiration date of the electronic certificate has been exceeded. In another possible example, the signature inspecting unit 85 compares a value calculated using the received public key and a public key included in the electronic certificate with the value of the received signature information, and checks whether these values are identical with each other.

When the signature inspecting unit 85 confirms the authenticity of the public key of the analysis server 30, the key managing unit 86 generates a common key using the public key of the analysis server 30 and the private key of the user. The key managing unit 86 records the generated common key (common key of the analysis server 30 and the user), the public key of the analysis server 30, and the private key of the user in a key management table 92 in association with each other. The concealed-information restoring unit 83 uses the recorded common key to decrypt the cryptographic data received from the analysis server 30.

When an analysis-result requesting process starts, according to whether for-inspection information is stored in the storage unit 91, the key managing unit 86 determines whether that is the first time the analysis-result requesting process is performed or whether that is the second or later time the analysis-result requesting process is performed. When the key managing unit 86 determines that that is the first time to perform the analysis-result requesting process, the key managing unit 86 generates a private key of the user and a public key corresponding to the private key, and instructs the signature creating unit 87 to generate signature information of the generated public key. A used key generation algorithm is such that the common key generated from the public key of the user and the private key of the analysis server 30 becomes identical with the common key generated from the public key of the analysis server 30 and the private key of the terminal 80. The key generation algorithm is, for example, a Diffie-Hellman scheme. Meanwhile, when the key managing unit 86 determines that that is the second or later time the analysis-result requesting process is performed, the key managing unit 86 generates a private key different from private keys used in previously performed analysis-result requesting processes, generates a public key corresponding to the private key, and instructs the signature creating unit 87 to generate a hash value of the common key as a signature of the generated public key. Assume that a private key is associated with identification information for unique identification of each user of a terminal 80. A used key generation algorithm is such that the common key generated from the public key of the user and the private key of the collection server 10 becomes identical with the common key generated from the public key of the collection server 10 and the private key of the terminal 80. The key generation algorithm is, for example, a Diffie-Hellman scheme.

When the key managing unit 86 instructs the signature creating unit 87 to generate signature information of a public key, the signature creating unit 87 generates signature information by signing a public key of the user using a public key of an electronic certificate registered in advance. The electronic certificate includes a public key used to generate signature information, and owner information of the public key. The public key included in the electronic certificate is different from the public key generated by the key managing unit 86. When the signature creating unit 87 generates signature information, the signature creating unit 87 records the private key of the user, the public key, the signature information, and the electronic certificate in the key management table 92 in association with each other.

When the key managing unit 86 instructs the signature creating unit 87 to generate a hash value of a common key as signature information of a public key, the signature creating unit 87 generates the common key using for-inspection information 93 and a private key generated by the key managing unit 86. The generated common key serves as a signature of a public key that the key managing unit 86 has made an instruction to generate. For-inspection information is information on the public key of the collection server 10, as described above. The signature creating unit 87 calculates a hash value of the generated common key using a predetermined hash function. After calculating the hash value, the signature creating unit 87 records the private key of the user, the public key, the generated common key (common key of the collection server and the user), and the hash value in the key management table 92 in association with each other.

The application processing unit 88 performs application-based data processing.

The display apparatus 89 displays data processed by the terminal 80 so that the user can see the data. The display apparatus 89 displays, for example, a result of processing performed by the application processing unit 88.

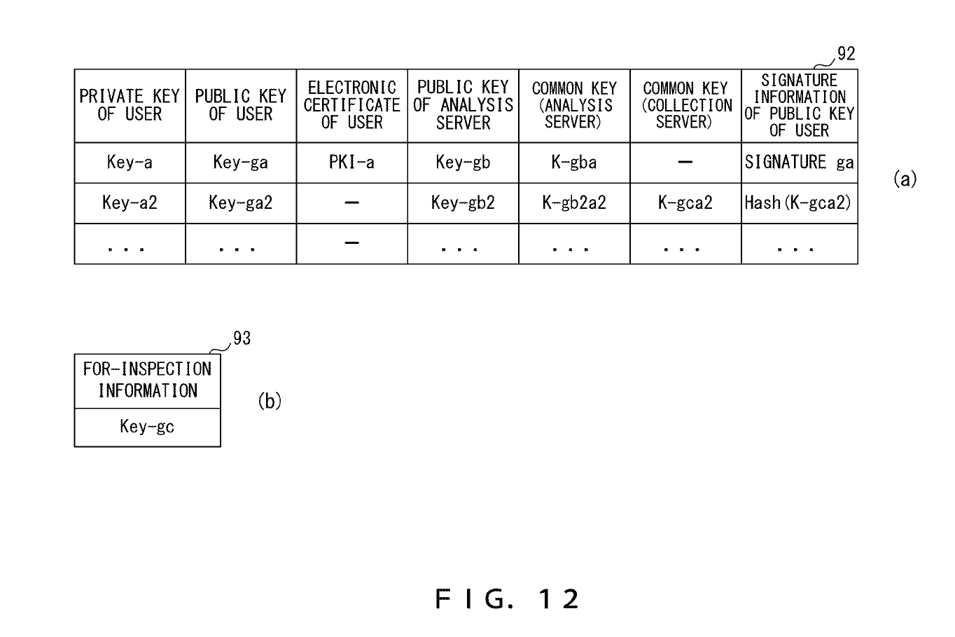

The storage unit 91 stores the key management table 92 and for-inspection information 93. FIG. 12 depicts an example of information stored by the storage unit 91. In FIG. 12, (a) indicates an exemplary configuration of the key management table 92, and (b) indicates an exemplary configuration of for-inspection information 93. In the example of (a) in FIG. 12, a private key of a user, a public key of the user, an electronic certificate, a public key of an analysis server, a common key of the analysis server and the user, a common key of a collection server and the user, and signature information are recorded in association with each other. When the analysis-result requesting process is performed for the first time, signature information signing the public key of the user using the public key of the electronic certificate is stored as the “signature information” of (a) in FIG. 12; when the analysis-result requesting process is performed for the second or later time, a hash value of a common key is stored as the “signature information” of (a) in FIG. 12.

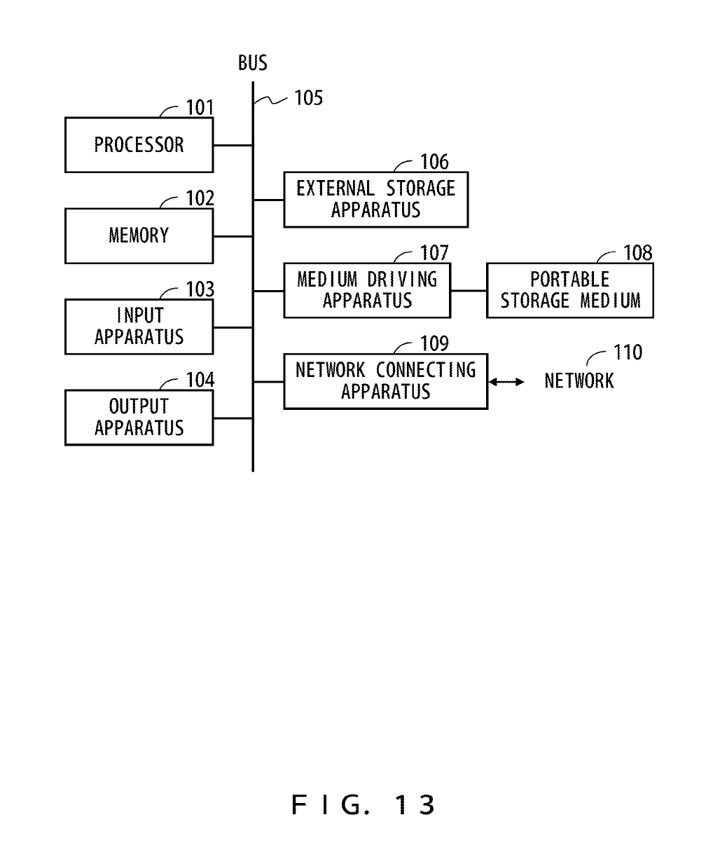

FIG. 13 illustrates exemplary hardware configurations of a server, the communication apparatus 60, and the terminal 80. The collection server 10, the analysis server 30, the communication apparatus 60, and the terminal 80 may have the hardware configuration depicted in FIG. 13. The hardware configuration includes a processor 101, a memory 102, an input apparatus 103, an output apparatus 104, a bus 105, an external storage apparatus 106, a medium driving apparatus 107, and a network connection apparatus 109, this configuration is like a computer. The collection server 10, the analysis server 30, the communication apparatus 60, and the terminal 80 may be achieved by, for example, a computer.

The processor 101 may be an arbitrary processing circuit that includes a Central Processing Unit (CPU). In the collection server 10, the processor 101 is operated as the information collecting unit 14, the ID-conversion processing unit 15, the authentication unit 16, the session managing unit 17, the analysis-ID managing unit 18, the signature inspecting unit 19, the key managing unit 20, and the application processing unit 21. In the analysis server 30, the processor 101 is operated as the authentication unit 34, the access-identifier generating unit 35, the address solution unit 36, the sequence managing unit 37, the key managing unit 38, and the application processing unit 40. In the communication apparatus 60, the processor 101 is operated as the authentication unit 64, the ID managing unit 65, the proxy authentication unit 66, the session managing unit 67, and the sequence managing unit 68. In the terminal 80, the processor 101 is operated as the concealed-information restoring unit 83, the session managing unit 84, the signature inspecting unit 85, the key managing unit 86, the signature creating unit 87, and the application processing unit 88. The processor 101 is operated as these units by executing, for example, a program stored in the external storage apparatus 106.

The memory 102 properly stores data obtained from an operation of the processor 101 and data to be used in processing performed by the processor 101. The memory 102 is operated as the storage unit 22 in the collection server 10, as the storage unit 50 in the analysis server 30, as the storage unit 70 in the communication apparatus 60, and as the storage unit 91 in the terminal 80.

The network connection apparatus 109 performs processing for a communication with another apparatus. The network connection apparatus 109 is operated as the receiving unit 12 and the transmitting unit 13 in the collection server 10, and as the receiving unit 32 and the transmitting unit in the analysis server 30. The network connection apparatus 109 is operated as the receiving unit 62 and the transmitting unit 63 in the communication apparatus 60, and as the transmitting unit 81 and the receiving unit 82 in the terminal 80.

The input apparatus 103 is achieved as, for example a button, keyboard, or mouse, and the output apparatus 104 is achieved as, for example, a display. In one possible example, the output apparatus 104 is operated as the display apparatus 89 in the terminal 80. The bus 105 connects the processor 101, the memory 102, the input apparatus 103, the output apparatus 104, the external storage apparatus 106, the medium driving apparatus 107, and the network connection apparatus 109 so that data can be transferred therebetween. The external storage apparatus 106 stores a program and data and properly provides stored information to, for example, the processor 101. The medium driving apparatus 107 outputs data from the memory 102 and the external storage apparatus 106 to a portable storage medium 108 and reads, for example, a program or data from the portable storage medium 108. The portable storage medium 108 is an arbitrary portable storage medium, e.g., a floppy disk, Magneto-Optical (MO) disk, Compact Disc Recordable (CD-R), or Digital Versatile Disk Recordable (DVD-R).

### Embodiments

In the following, an exemplary situation will be described in which F High School administers the collection server 10 and a request has been made for the analysis server 30 to analyze test results of students. Thus, the following descriptions are based on a condition in which users who attempt to refer to the analysis server 30 are students of F High School. The analysis server 30 transmits, to a user who has made a request to allow an analysis result to be referred to, data obtained from a test result of the user.

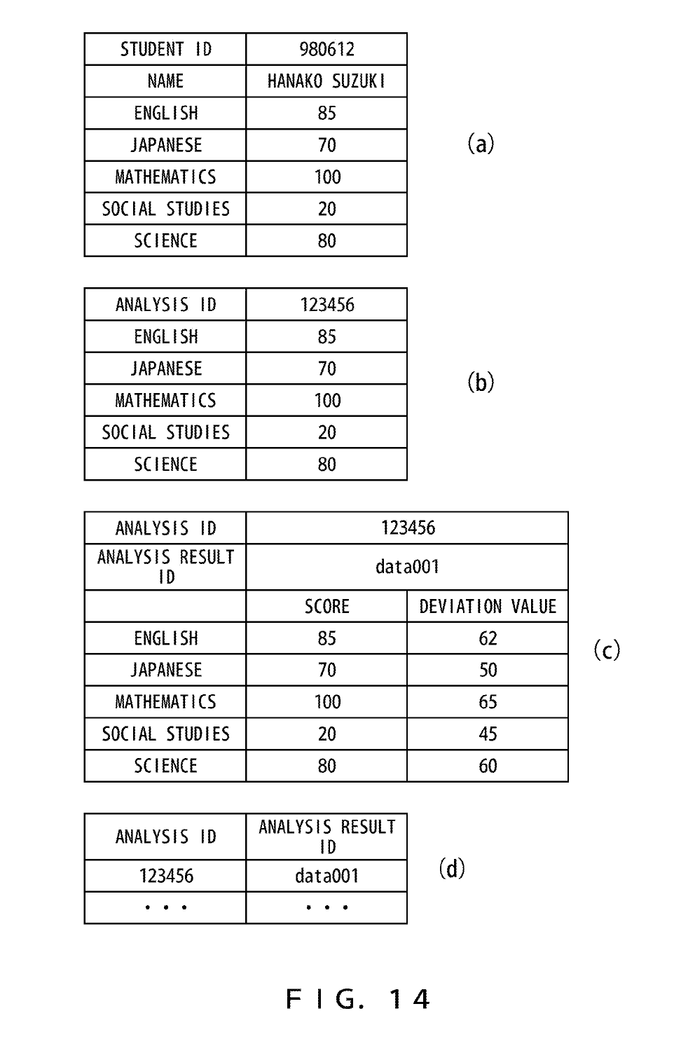

FIG. 14 illustrates a method for generating substitution data, and an exemplary analysis result of substitution data. (a) in FIG. 14 depicts an example of a test result of one of the students for whom an analysis is made. A test result of each subject is associated with the name or student ID of an examinee. In this example, the name and student ID of examinees are concealed from a third party and are treated as concealed information. Accordingly, in the collection server 10, the analysis-ID managing unit 18 first determines analysis IDs that can uniquely identify students for whom a test result is obtained, thereby generating the analysis ID table 23 (see FIG. 6). After the analysis ID table 23 is generated, the ID-conversion processing unit 15 replaces concealed information with an analysis ID using the analysis ID table 23. To convert the test result in (a) of FIG. 14 into substitution data using the analysis ID table 23 illustrated in FIG. 6, the ID-conversion processing unit 15 replaces the student ID and the name, both of which are concealed information, with an analysis ID associated with the student ID. Through this replacing process, the ID-conversion processing unit 15 generates the substitution data indicated by (b) in FIG. 14 from the information indicated by (a) in FIG. 14. The ID-conversion processing unit 15 performs a similar process for the test results of all of the students for whom a request is made for the analysis server 30 to make an analysis. In addition, the ID-conversion processing unit 15 transmits the generated substitution data to the analysis server 30.

When substitution data is received by the analysis server 30 from the collection server 10, the analyzing unit 41 analyzes the substitution data. An analysis result for each user is recorded in association with an analysis ID. When a result obtained from an analysis is a deviation value of the score of each subject, the analyzing unit 41 may hold the analysis result indicated by (c) in FIG. 14 for the user with analysis ID=123456. Meanwhile, as indicated by (d) in FIG. 14, the analyzing unit 41 may generate metadata for readily determining whether an analysis result is present for each user.

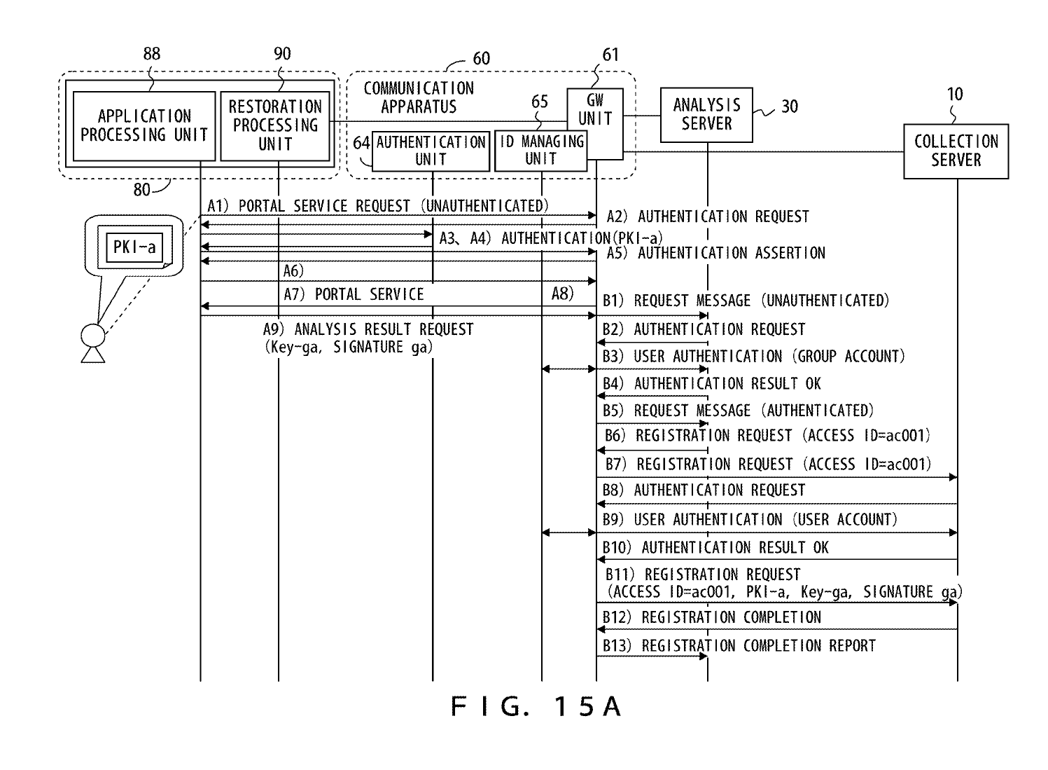

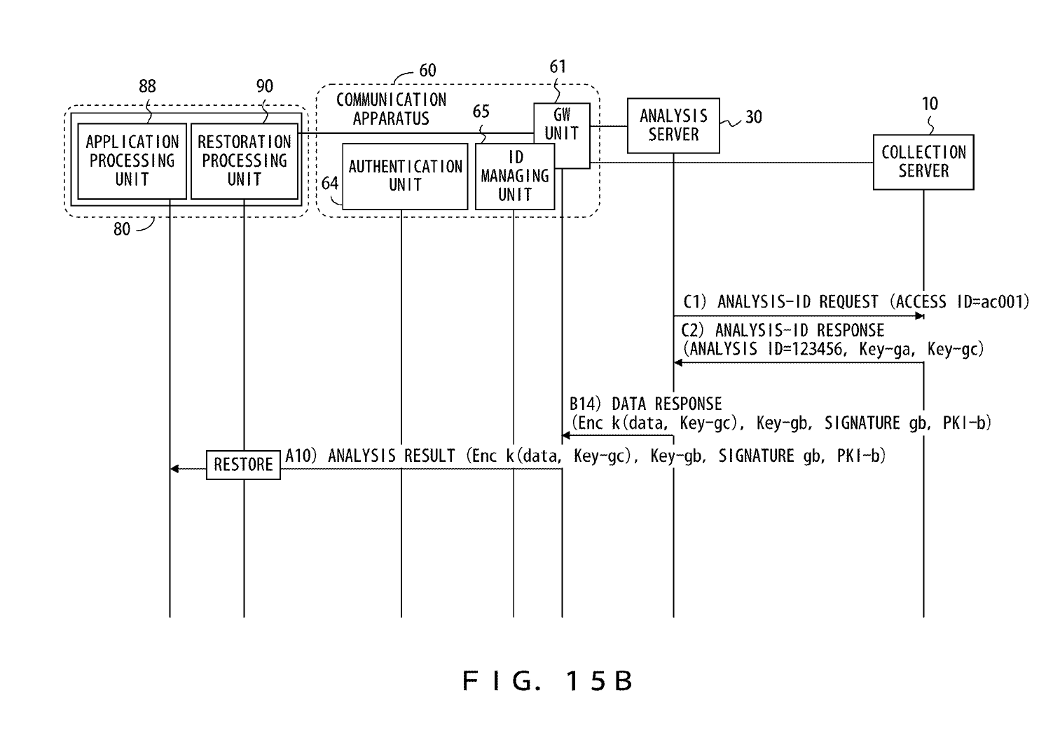

FIGS. 15A and 15B are sequence diagrams illustrating an exemplary communication performed when a user makes a request to obtain an analysis result for the first time in accordance with an embodiment. With reference to FIGS. 15A and 15B, the following will describe examples of a communication and exchanging of a public key performed when a user makes a request for the analysis server 30 to report an analysis result after the analysis server 30 finishes an analysis. In the following descriptions, a student who has the test result indicated by (a) in FIG. 14 is a user. In the examples of FIGS. 15A and 15B, proxy authentication is performed between the terminal 80 and the communication apparatus 60 using Security Assertion Markup Language (SAML).

(A1) Using the terminal 80, the user makes a request for the communication apparatus 60 to enable a portal site to be accessed (a portal service request), the portal site including a menu that allows an analysis result to be browsed.

(A2) When the communication apparatus 60 makes a request to perform authentication (this request will hereinafter be referred to as an authentication request), the key managing unit 86 of the terminal 80 generates a private key of the user and a public key corresponding to the private key of the user. The signature creating unit 87 generates signature information of the public key using an electronic certificate registered in advance, and stores the generated private key of the user, the public key of the user, signature information of the public key of the user, and the electronic certificate in the key management table 92 in association with each other. The electronic certificate includes identification information of the user as information on the owner of the public key. The electronic certificate is also used for authentication for access to the communication apparatus 60. The private key of the user, the public key, the signature information, and the electronic certificate may be stored in advance in the key management table 92 in the storage unit 91 of the terminal 80.

(A3) The application processing unit 88 of the terminal 80 transmits the electronic certificate together with an authentication request to the communication apparatus 60. Assume that the electronic certificate indicates “hanako” as an owner.

(A4) The receiving unit 62 of the communication apparatus 60 outputs an authentication request to the authentication unit 64. The authentication unit 64 sends a query to the issuer of the electronic certificate so as to determine whether the owner of the electronic certificate is authentic. When the owner is judged to be authentic, the terminal 80 is allowed to gain access. The authentication unit 64 of the communication apparatus 60 issues an authentication assertion to the terminal 80.

(A5) By transmitting the authentication assertion to the communication apparatus 60, the application processing unit 88 of the terminal 80 reports to the communication apparatus 60 that authentication has succeeded.

(A6) When the authentication assertion is received, the session managing unit 67 of the communication apparatus 60 assigns a first session ID to the terminal 80 and reports the first session ID to the terminal 80. The report includes, for example, Set Cookie header of HyperText Transfer Protocol (HTTP).

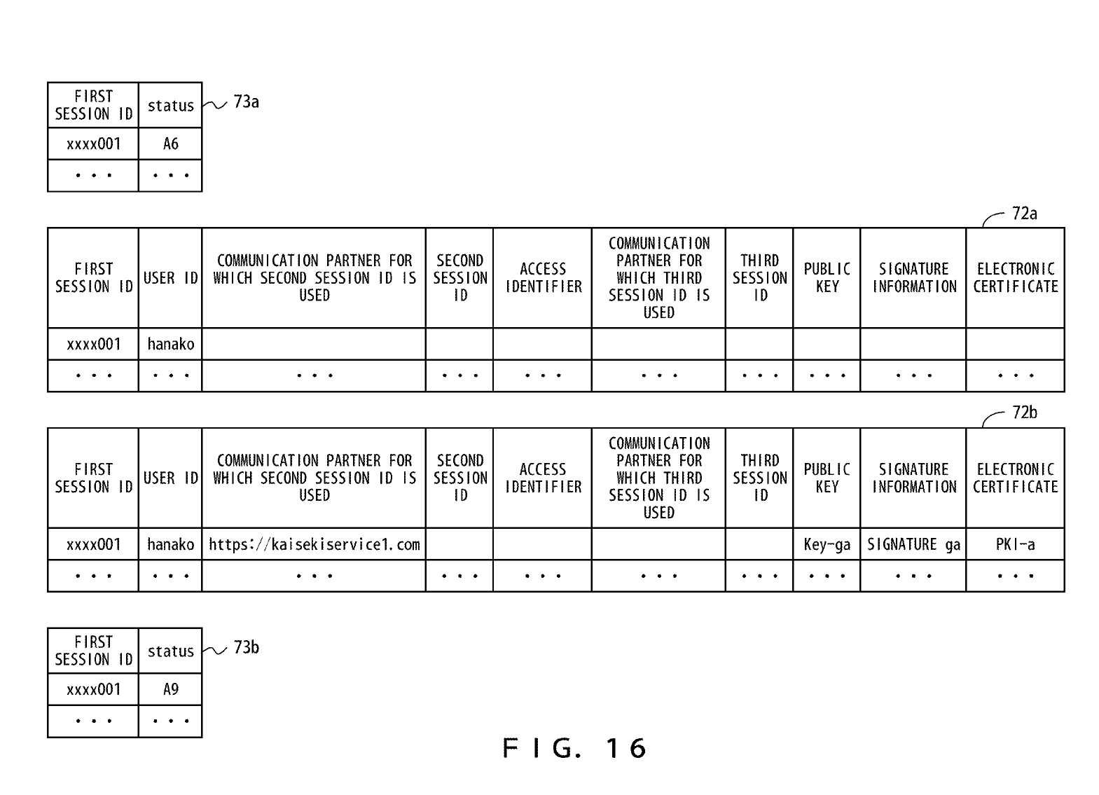

FIG. 16 illustrates an example of the updating of information based on a communication between the terminal 80 and the communication apparatus 60. When a first session ID is generated, the sequence managing unit 68 records the progress of the procedures of a communication between the terminal 80 and the communication apparatus 60 in the session management table 73 in association with the first session ID. Assume, for example, that the first session ID assigned to a communication with the terminal 80 is “xxxx001”. Accordingly, as of procedure (A6), the sequence managing unit 68 holds a session management table 73a illustrated in FIG. 16.

(A7) By transmitting a portal service request to the communication apparatus 60, the application processing unit 88 makes a request to allow the portal site that includes an analysis-result browsing menu to be accessed. The message used to make a request to allow the portal site to be accessed includes the first session ID.

(A8) The communication apparatus 60 transmits to the terminal 80 data used to display the portal site. Simultaneously, the authentication unit 64 associates the first session ID with the owner information of the electronic certificate reported in the performing of authentication in procedure (A3), i.e., user identification information, so as to record, in the cooperation table 72, information on the user who has made a request to allow the portal site to be accessed. As of procedure (A8), the communication apparatus 60 holds a cooperation table 72a illustrated in FIG. 16. The owner information of an electronic certificate reported from the terminal 80 to the communication apparatus 60 in the performing of authentication in procedure (A3) will hereinafter be referred to as a “user ID”.

Meanwhile, the receiving unit 82 of the terminal 80 outputs to the application processing unit 88 data received from the communication apparatus 60. Using the input data, the application processing unit 88 displays on the display apparatus 89 the portal site that includes an analysis-result browsing menu.

(A9) The user checks the portal site on the display apparatus 89 and chooses to browse an analysis result using an input apparatus. Accordingly, the application processing unit 88 transmits to the communication apparatus 60 an analysis result request, which indicates a request to allow an analysis result to be browsed. The analysis result request includes a first session ID, the address (URL) of the analysis server 30 that holds the analysis result, a public key of the user, and signature information of the public key. It is assumed that the session managing unit 67 has an ability to recognize an address for which access is requested by the analysis result request. Accordingly, when the communication apparatus 60 receives the analysis result request, the session managing unit 67 updates the cooperation table 72a to the cooperation table 72b illustrated in FIG. 16. The cooperation table 72b indicates an example in which the address of the analysis server 30 “https://kaisekiservice1.com”, the public key “Key-ga”, signature information “signature ga”, and the electronic certificate “PKI-a” are designated. For information on an electronic certificate, the session managing unit 67 obtains the information already received by the authentication unit 64 in (A4). The sequence managing unit 68 updates the session management table 73 to the session management table 73b illustrated in FIG. 16.

Next, with reference to (B1) to (B7) in FIG. 15A, descriptions will be given of an example of a process series from a process in which the communication apparatus 60 accesses the analysis server 30 to a process in which an access identifier is reported to the communication apparatus 60.

(B1) The proxy authentication unit 66 obtains, from “COMMUNICATION PARTNER FOR WHICH SECOND SESSION ID IS USED” of the cooperation table 72b, an address for which access has been requested by an analysis result request, and, according to the obtained result, determines that an access destination is the analysis server 30. Accordingly, the proxy authentication unit 66 transmits a request message for requesting an analysis result to the analysis server 30. In this case, since authentication has not been performed between the communication apparatus 60 and the analysis server 30 yet, the request message does not include a second session ID.

(B2) The authentication unit 34 of the analysis server 30 makes a request for the proxy authentication unit 66 of the communication apparatus 60, i.e., the source of the request message that does not include a second session ID, to perform authentication.

(B3) Using the ID management table 71, the proxy authentication unit 66 specifies an account and a password, both used for authentication with the analysis server 30. In this example, the proxy authentication unit 66 searches the ID management table 71 using as keys the user ID and the URL of the analysis server 30 “https://kaisekiservice1.com”. The proxy authentication unit 66 specifies the user ID from the cooperation table 72b and the first session ID included in the analysis result request. Accordingly, as information to be used for proxy authentication, the proxy authentication unit 66 obtains a group account and a password, both assigned to the group to which the user belongs (F High School). The following descriptions will be based on a condition in which the proxy authentication unit 66 has chosen to use a group account “d001” and a password “pw001” for proxy authentication by referring to the ID management table 71 (FIG. 10). Using the group account and password that have been chosen to be used for proxy authentication, the proxy authentication unit 66 transmits, to the analysis server 30, an authentication request message for making a request to perform authentication.

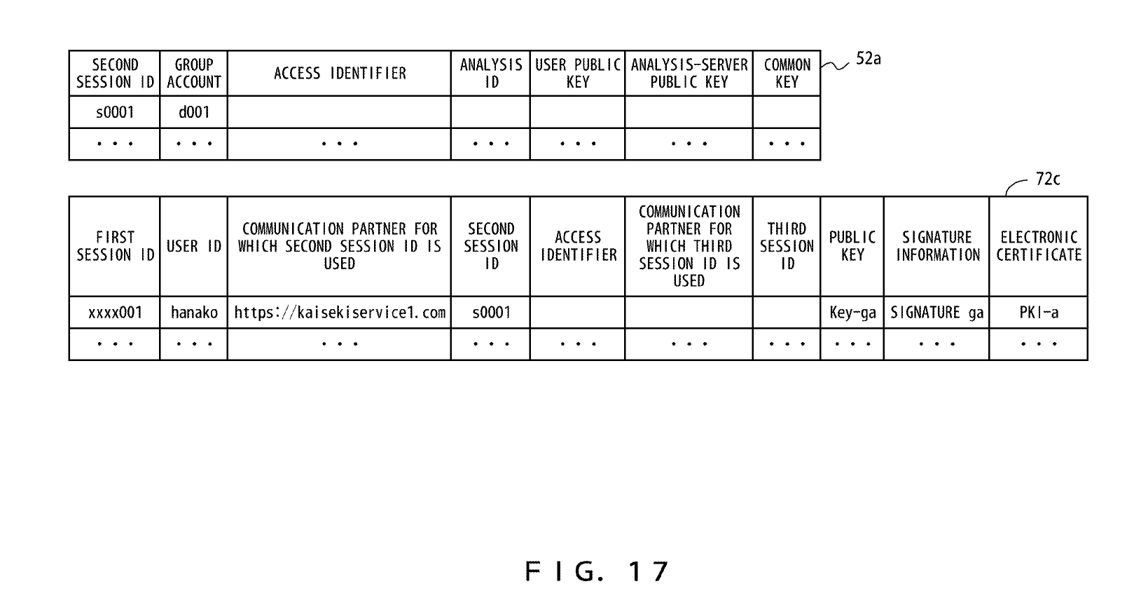

(B4) In the analysis server 30, upon receipt of the authentication request message from the communication apparatus 60, the receiving unit 32 outputs the authentication request message to the authentication unit 34. When any of the combinations of an account and a password stored in advance are identical with the combination of a group account and a password included in the input information, the authentication unit 34 allows the communication apparatus 60 to gain access and generates a second session ID. The following descriptions will be based on a condition in which “S0001” has been generated as a second session ID. With reference to FIG. 17, the following will describe an example of the updating of information according to authentication between the communication apparatus 60 and the analysis server 30. When authentication at the authentication unit 34 succeeds, the access-identifier generating unit 35 records the second session ID and the group account in association with each other, as indicated by an analysis ID table 52a in FIG. 17. In addition, the authentication unit 34 reports the second session ID to the communication apparatus 60.

(B5) The receiver 62, which has received a report message that includes the second session ID from the analysis server 30, outputs the received report message to the proxy authentication unit 66 and the session managing unit 67. Upon receipt of the second session ID from the report message, the session managing unit 67 updates the cooperation table 72b (FIG. 16) to the cooperation table 72c (FIG. 17). The proxy authentication unit 66 generates and transmits a request message that includes the second session ID to the analysis server 30 via the transmitting unit 63.

(B6) In the analysis server 30, upon receipt of the request message from the communication apparatus 60, the receiving unit 32 outputs the request message to the access-identifier generating unit 35. By referring to the analysis ID table 52a (FIG. 17), the access-identifier generating unit 35 determines whether an access identifier is associated with the second session ID included in the request message. However, the second session ID included in the received request message, “S0001”, is not associated with an access identifier. Accordingly, the access-identifier generating unit 35 selects an access identifier to be associated with the second session ID. The following descriptions will be based on a condition in which the access identifier associated with the second session ID “S0001” is “ac001”.

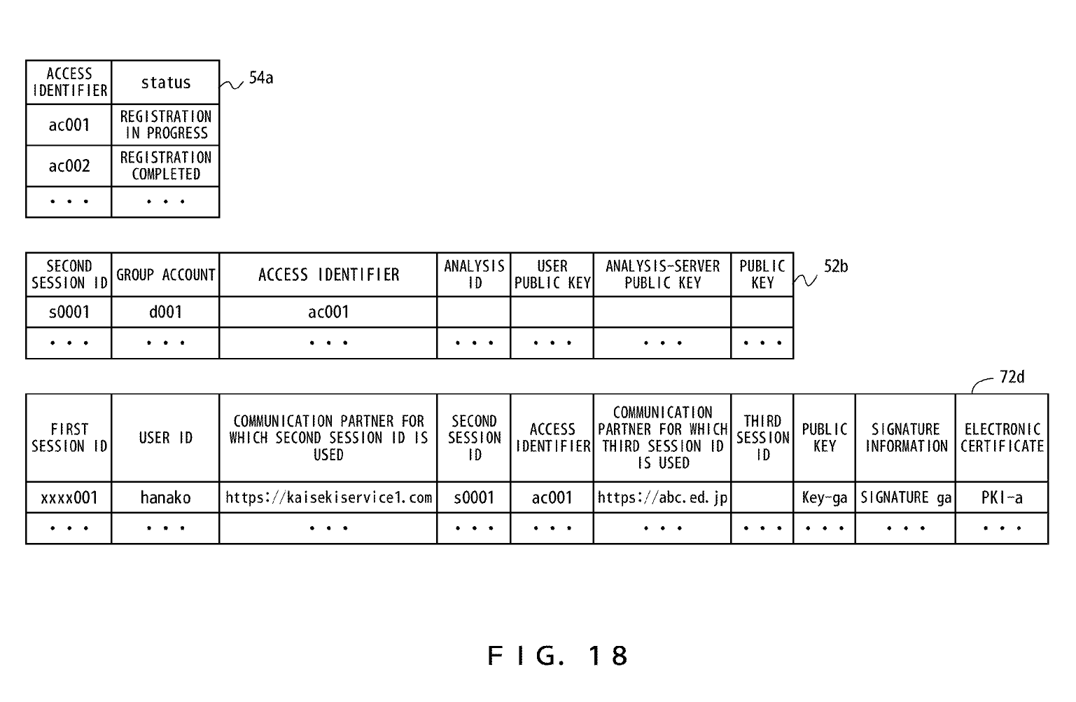

With reference to FIG. 18, the following will describe an example of the updating of information in reporting of an access identifier from the analysis server 30 to the communication apparatus 60. The access-identifier generating unit 35 selects and records an access identifier in the analysis ID table 52. In one possible example, the access-identifier generating unit 35 updates the analysis ID table 52a (FIG. 17) to the analysis ID table 52b (FIG. 18). When the access-identifier generating unit 35 selects an access identifier, the access-identifier generating unit 35 reports to the sequence managing unit 37 a combination of the access identifier and a second session ID. Accordingly, the sequence managing unit 37 updates the state table 54, which is used to determine whether the access identifier reported from the access-identifier generating unit 35 is registered in the collection server 10. In one possible example, the access-identifier generating unit 35 updates the state table 54 to, for example, a state table 54a illustrated in FIG. 18.

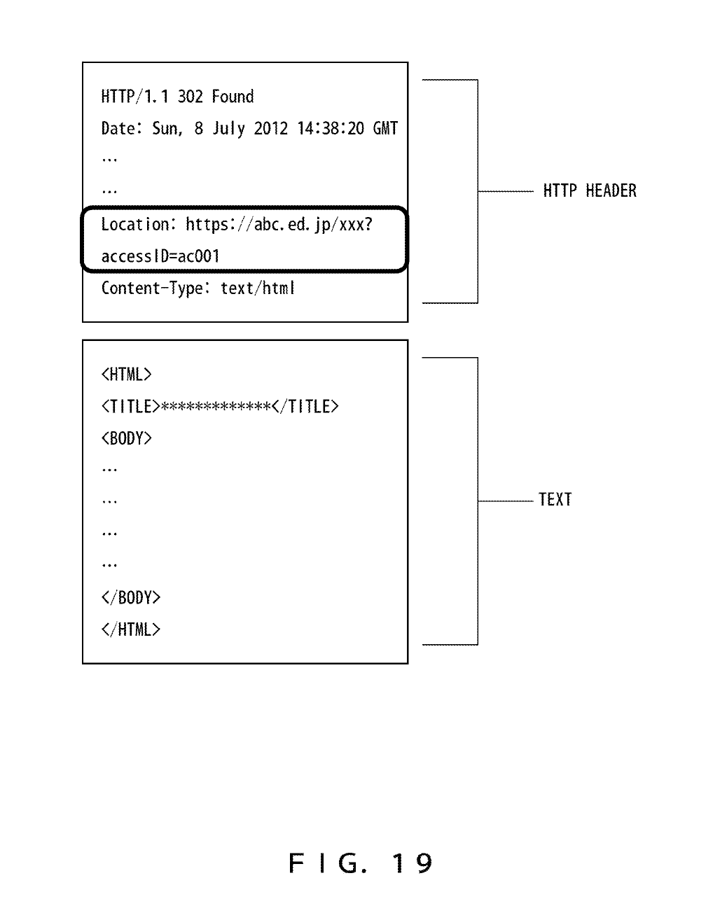

In addition, the access-identifier generating unit 35 generates a registration request message for registering an access identifier in the collection server 10. To generate a registration request message, the access-identifier generating unit 35 refers to the account table 53 (FIG. 8) so as to specify an address and URL assigned to the collection server 10, i.e., a data server in which the access identifier is to be registered. The following descriptions will be based on a condition in which “https://abc.ed.jp” has been specified as a URL assigned to the collection server 10. FIG. 19 illustrates an example of a registration request message. As will be described hereinafter, the registration request message illustrated in FIG. 19 is transmitted from the communication apparatus 60 to the collection server 10 using HTTP redirect. The access-identifier generating unit 35 transmits the registration request message that includes the specified address to a communication partner identified by the second session ID.

(B7) The receiving unit 62, which has received a registration request message, outputs this registration request message to the session managing unit 67. Using the registration request message, the session managing unit 67 updates the cooperation table 72c (FIG. 17) to the cooperation table 72d (FIG. 18). Moreover, the session managing unit 67 transmits the registration request message to the collection server 10. In one possible example, upon receipt of the registration request message illustrated in FIG. 19, the session managing unit 67 modifies this registration request message into a registration request message addressed to the collection server 10 and transmits the modified registration request message to the collection server 10 via the transmitting unit 63.

(B8) The receiving unit 12 of the collection server 10, which has received the modified registration request message, outputs this registration request message to the authentication unit 16. The authentication unit 16 determines whether the registration request message includes a third session ID. When a third session ID is not included, the authentication unit 16 makes a request for the source of the registration request message to perform authentication. However, since authentication has not been performed between the communication apparatus 60 and the collection server 10, the authentication unit 16 transmits an authentication request message to the communication apparatus 60 via the transmitting unit 13. In this case, the authentication unit incorporates the access identifier included in the registration request message into the authentication request message. Accordingly, the authentication request message that includes access identifier “ac001” is transmitted to the communication apparatus 60.

(B9) Upon receipt of the authentication request message from the collection server 10, the receiving unit 62 of the communication apparatus 60 outputs the authentication request message to the proxy authentication unit 66. Using the access identifier included in the authentication request message as a key, the proxy authentication unit 66 searches the cooperation table 72d (FIG. 18). In accordance with the cooperation table 72d, the requested authentication is judged to be access to “https://abc.ed.jp”, which relates to a user ID “hanako”. Accordingly, the proxy authentication unit 66 searches the ID management table 71 using the user ID and the access destination as keys so as to specify an account and password to be used for authentication. The ID management table 71 (FIG. 10) records a user account determined for each user as an account for making a request for the collection server 10 to perform authentication. Thus, the user account is used for authentication from the communication apparatus 60 to the collection server 10. In the case of, for example, the ID management table 71 illustrated in FIG. 10, the account used for authentication is “986012”, and the password is “pwxxx”. Using the account and password specified using the ID management table 71, the proxy authentication unit 66 makes a request for the collection server 10 to perform authentication.

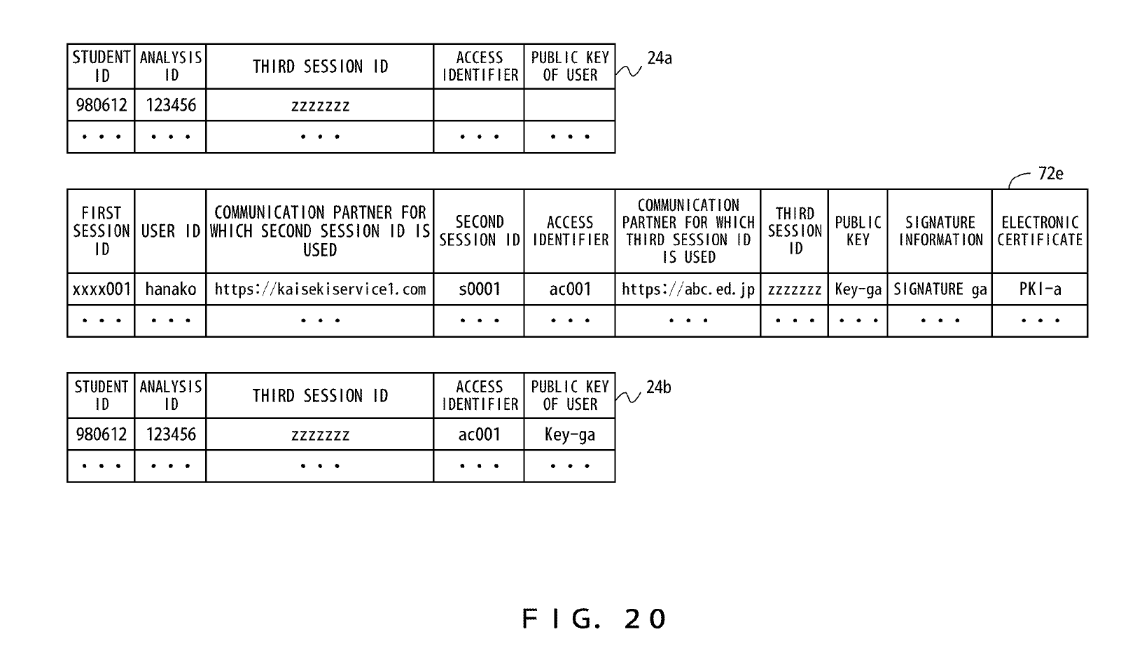

(B10) Upon receipt of the authentication request from the communication apparatus 60, the receiving unit 12 of the collection server 10 outputs the authentication request to the authentication unit 16. When an authentication request is input that includes a combination of an account and a password identical with any of the combinations of a user account and a password stored in advance, the authentication unit 16 allows access from the communication apparatus 60. In addition, the authentication unit 16 outputs to the session managing unit 17 the user account of a user who has been newly successfully authenticated. The session managing unit 17 generates a third session ID for the user account reported from the authentication unit 16. Moreover, using the analysis-ID table 23, the session managing unit 17 associates the newly generated third session ID with an analysis ID so as to generate a session management table 24. Assume, for example, that the third session ID “zzzzzzz” is assigned to access from account “986012”. Accordingly, the session managing unit 17 generates a session management table 24a illustrated in FIG. 20. The session managing unit 17 reports the success of authentication and the third session ID to the communication apparatus 60.

(B11) Upon receipt of a message reporting the success of authentication, the receiving unit 62 of the communication apparatus 60 outputs this message to the session managing unit 67. The session managing unit 67 processes the input message so as to update the cooperation table 72d (FIG. 18) to a cooperation table 72e (FIG. 20). The session managing unit 67 generates a registration request message that includes access identifier “ac001”, the third session ID, a public key, signature information of the public key, and an electronic certificate. The registration request message is transmitted to the collection server 10 via the transmitting unit 63.

(B12) Upon receipt of the registration request message that includes the third session ID, the receiving unit 12 of the collection server 10 outputs this received message to the session managing unit 17. Accordingly, the session managing unit 17 first outputs the received registration request message to the signature inspecting unit 19. The signature inspecting unit 19 determines whether the registration request message includes an electronic certificate. When the signature inspecting unit 19 determines that the registration request message includes an electronic certificate, the signature inspecting unit 19 determines that the received registration request message is a massage made in an initial login from the terminal 80. The signature inspecting unit 19 inspects the authenticity of a public key using signature information and the electronic certificate. In one possible example, the signature inspecting unit 19 first inquires with the issuer of the electronic certificate as to whether the owner of the electronic certificate is authentic. Then, the signature inspecting unit 19 uses signature information and the electronic certificate so as to determine whether the public key has been falsified or secretly replaced. After the inspecting, when the signature inspecting unit 19 determines that the received public key of the user is authentic, the signature inspecting unit 19 reports to the session managing unit 17 that the authenticity of the public key has been confirmed. When the session managing unit 17 receives a report that the authenticity of the public key has been confirmed, the session managing unit 17 performs the following operations. That is, the session managing unit 17 searches the session management table 24 using as a key the third session ID included in the input registration request message. The session managing unit 17 registers an entry hit in the search in association with the public key of the user and the access identifier reported by the registration request message. Through this process, the session management table 24a illustrated in FIG. 20 is updated to, for example, the session management table 24b illustrated in FIG. 20. When the updating of the session management table 24 is finished, the session managing unit 17 generates a registration completion message for reporting the completion of registering of the access identifier to the communication apparatus 60, and transmits this message to the communication apparatus 60 via the transmitting unit 13. The registration completion message includes the access identifier that has been registered.

(B13) Upon receipt of the registration completion message, the receiving unit 62 of the communication apparatus 60 outputs this message to the session managing unit 67. For the access identifier included in the registration completion message, the session managing unit 67 generates a message for reporting to the analysis server 30 that the registering has been completed (a registration-completion report message). Moreover, using the cooperation table 72e illustrated in FIG. 20, the session managing unit 67 specifies the second session ID and the address assigned to the analysis server 30.

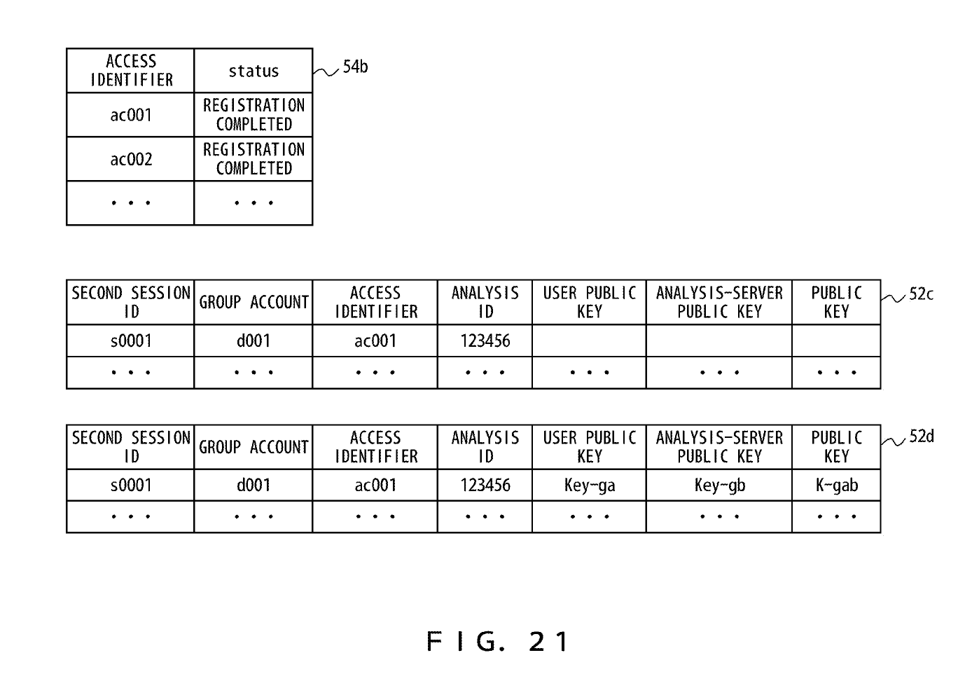

(C1) With reference to FIGS. 15B and 21, the following will describe an example of the updating of information after an access identifier is registered in the collection server 10. Upon receipt of a registration-completion report message from the communication apparatus 60, the receiving unit 32 of the analysis server 30 outputs this message to the access-identifier generating unit 35 and the sequence managing unit 37. Using the registration-completion report message, the sequence managing unit 37 updates the state table 54a (FIG. 18) to the state table 54b (FIG. 21). The access-identifier generating unit 35 generates a message for requesting an analysis ID associated with the access identifier for which registration completion has been reported (analysis-ID request message). The access-identifier generating unit 35 incorporates information on the access identifier into the generated analysis-ID request message. In the generating of the analysis-ID request message, the access-identifier generating unit 35 refers to the analysis-ID table 52 so as to obtain a group account associated with an access identifier for which registration completion has been reported. In one possible example, the access-identifier generating unit 35 refers to the analysis ID table 52b (FIG. 18) so as to obtain group account “d001”. The access-identifier generating unit 35 obtains the address of the collection server 10 by searching the account table 53 using the obtained group account as a key. The access-identifier generating unit 35 transmits the analysis-ID request message to the collection server 10.

(C2) Upon receipt of the analysis-ID request message from the analysis server 30, the receiving unit 12 of the collection server 10 outputs the analysis-ID request message to the session managing unit 17. Accordingly, the session managing unit 17 refers to the session management table so as to obtain information on an analysis ID and a public key of the user. That is, the session managing unit 17 searches the session management table 24 using an access identifier included in the analysis-ID request message as a key. The session managing unit 17 obtains an analysis ID of an entry hit in the search and information on the public key of the user. Next, the session managing unit 17 determines whether for-inspection private information is present. That is, the session managing unit 17 searches the session management table 24 using an access identifier included in the analysis-ID request message as a key. The session managing unit 17 obtains a student ID of an entry hit in the search. Next, the session managing unit 17 searches the analysis-ID table 23 using the obtained student ID as a key. The session managing unit 17 determines whether for-inspection private information is stored in an entry hit in the search. When the session managing unit 17 determines that for-inspection private information is not present, the session managing unit 17 outputs, to the key managing unit 20, a creation request report for for-inspection private information. Accordingly, the key managing unit 20 first generates a private key of the collection server 10 as for-inspection private information and then generates a private key corresponding to the generated private key as for-inspection information. Next, the key managing unit 20 stores the generated for-inspection private information in the analysis-ID table 23 in association with a student ID. The key managing unit 20 updates the analysis-ID table 23 from (a) to (b) in FIG. 6 by storing for-inspection private information. The key managing unit 20 reports to the session managing unit 17 that the storing of for-inspection private information has been completed together with reporting for-inspection information. Accordingly, the session managing unit 17 transmits, to the analysis server 30 and via a route that does not link to the communication apparatus 60, the requested analysis ID, the public key of the user, for-inspection information, and a confirmation report indicating that the collection server 10 has confirmed the authenticity of the public key of the user. Assume that an analysis ID associated with access identifier “ac001” has been requested. In this case, according to the session management table 24b (FIG. 20) and the analysis-ID table 23 (FIG. 6), the session managing unit 17 reports analysis ID “123456”, public key “Key-ga”, and for-inspection information “Key-gc” to the analysis server 30. When an analysis ID associated with access identifier “ac001” is requested, the received analysis-ID request designates “ac001” as an access identifier.

(B14) Upon receipt of an analysis ID, a public key of the user, for-inspection information, and a confirmation report from the collection server 10, the receiving unit 32 of the analysis server 30 outputs the received information to the access-identifier generating unit 35, the output unit 42, and the key managing unit 38. Using the input information, the access-identifier generating unit 35 updates the analysis ID table 52b (FIG. 18) to an analysis ID table 52c (FIG. 21).

The key managing unit 38 determines whether the input information includes a confirmation report. When the key managing unit 38 determines that the input information does not include a confirmation report, the key managing unit 38 determines that the authenticity of the public key of the user has not been confirmed, and performs an error process. In the error process, in one possible example, a report indicating that the authenticity of the public key of the user has not been confirmed is transmitted to the communication apparatus 60.

On the other hand, when the key managing unit 38 determines that the input information includes a confirmation report, the key managing unit 38 generates a common key using the input public key of the user. Specifically, the key managing unit 38 first generates a private key of the analysis server 30 and a public key corresponding to the private key. The key managing unit 38 generates signature information by signing the generated public key using an electronic certificate registered in advance.

Next, the key managing unit 38 generates a common key using the generated private key and the input public key of the user. The key managing unit 38 stores the public key of the user, the public key of the analysis server 30, and the generated common key in the analysis-ID table 52 in association with each other. In this situation, the key managing unit 38 updates the analysis ID table 52c in FIG. 21 to an analysis ID table 52d in FIG. 21.

The output unit 42 generates and outputs, to the key managing unit 38, a packet that includes an analysis result associated with an analysis ID reported from the collection server 10. Using the generated common key, the key managing unit 38 encrypts for-inspection information and information on the analysis result input from the output unit 42. The key managing unit 38 outputs the encrypted cryptographic data, a public key of the analysis server 30, signature information of the public key of the analysis server 30, and an electronic certificate to the transmitting unit 33 as analysis result responses.

As a response of procedure (B13) (analysis result response), the transmitting unit 33 transmits cryptographic data, a public key of the analysis server 30, signature information of the public key of the analysis server 30, and an electronic certificate to the communication apparatus 60. In the case of, for example, analysis ID=123456, the output unit 42 transmits to the communication apparatus 60 cryptographic data that includes an analysis result of (c) in FIG. 14.

(A10) Upon receipt of an analysis result response from the analysis server 30, the receiving unit 62 of the communication apparatus 60 outputs this response to the session managing unit 67. The session managing unit 67 transmits the input analysis result response to the terminal 80 via the transmitting unit 63. To specify the terminal 80, the session managing unit 67 uses information from the cooperation table 72. A packet that includes an analysis result is transmitted to the terminal 80 as a response of procedure (A9). During procedures (A9) to (A10), the communication between the communication apparatus 60 and the terminal 80 continues using, for example, keep-alive.

Upon receipt of an analysis result response from the communication apparatus 60, the receiving unit 82 of the terminal 80 outputs this response to the signature inspecting unit 85. Accordingly, the signature inspecting unit 85 inspects a public key of the analysis server 30 using an electronic certificate and signature information included in the analysis result response.

After the inspecting, when the authenticity of the public key of the analysis server 30 is confirmed, the key managing unit 86 generates a common key using a private key of the user and the public key of the analysis server 30. The concealed-information restoring unit 83 decrypts cryptographic data included in the analysis result response using the generated common key. The concealed-information restoring unit 83 outputs the decrypted data to the application processing unit 88. The application processing unit 88 displays an analysis result on the display apparatus 89.

Next, the concealed-information restoring unit 83 determines whether decrypted cryptographic data includes for-inspection information. When the concealed-information restoring unit 83 determines that the cryptographic data includes for-inspection information, the concealed-information restoring unit 83 stores the for-inspection information from the cryptographic data as for-inspection information 93 of the storage unit 91.

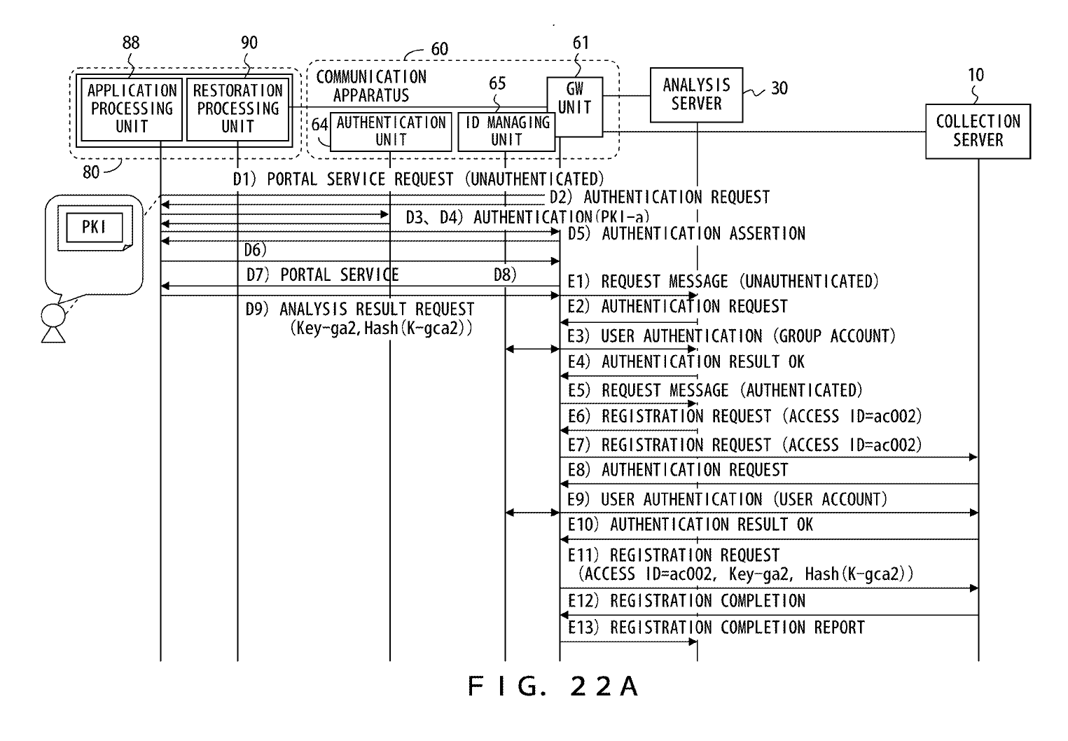

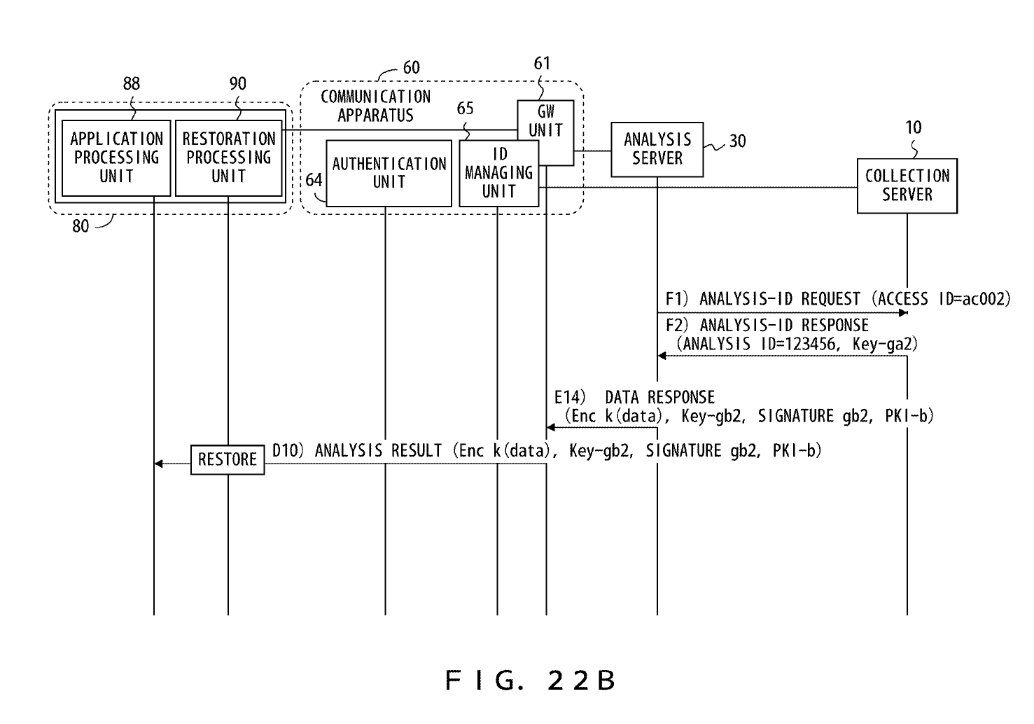

FIGS. 22A and 22B are sequence diagrams illustrating an exemplary communication performed when a user makes a request to obtain an analysis result for the second or later time in accordance with an embodiment.

Processes (D1)-(D10) are performed in communications between the terminal 80 and the communication apparatus 60. Procedures (D1)-(D8) are similar to the procedures (A1)-(A8) described above with reference to FIG. 15A.

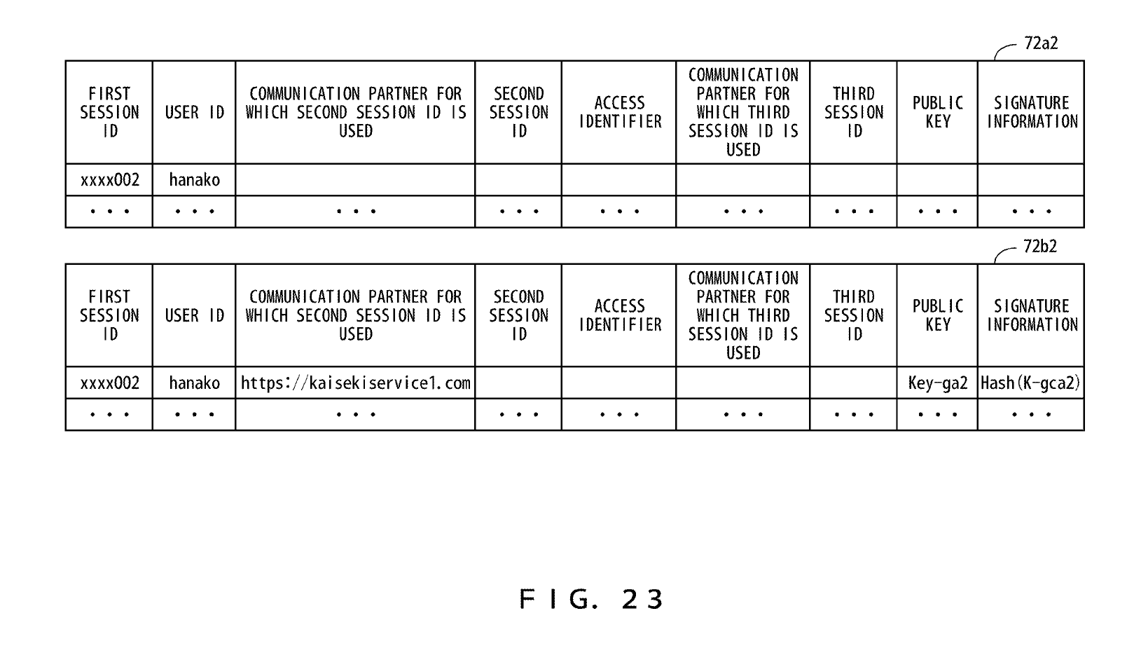

(D9) The user checks a portal site on the display apparatus 89 and chooses to browse an analysis result using an input apparatus. Then, the key managing unit 86 determines whether for-inspection information 93 is recorded. When the key managing unit 86 determines that for-inspection information 93 is recorded, the key managing unit 86 generates a new private key of the user and a public key corresponding to the new private key. Next, the signature creating unit 87 generates a common key from a public key of the collection server 10, i.e., for-inspection information, and the newly generated private key of the user, and defines this common key as an electronic signature. Then, the signature creating unit 87 records the private key of the user, the public key, and the generated common key in the key management table 92 in association with each other. The signature creating unit 87 calculates a hash value of the common key as signature information of the public key using a predetermined hash function. Accordingly, the application processing unit 88 transmits to the communication apparatus 60 an analysis result request, which indicates a request to allow an analysis result to be browsed. The analysis result request includes a first session ID, the address (URL) of the analysis server 30 that holds the analysis result, the newly created public key of the user, and the hash value (electronic certificate) of the common key generated using the public key. With reference to FIG. 23, the following will describe an example of the updating of information performed after an access identifier is registered in a collection server when a user makes a request to obtain an analysis result for the second or later time. Upon receipt of the analysis result request, the session managing unit 67 of the communication apparatus 60 updates a cooperation table 72a2 to a cooperation table 72b2. In this example, the address of the analysis server 30 “https://kaisekiservice1.com”, the public key “Key-ga2”, signature information “signature ga”, and the hash value of a common key “Hash(K-gca2)”, i.e., signature information, are designated. As in the case of initial login, the sequence managing unit 68 updates the session management table 73.

Subsequently, the processes of procedures (E1)-(E14) are performed in a communication between the communication apparatus 60 and the analysis server 30. Note that procedures (E1)-(E10) and (E13) are respectively similar to procedures (B1)-(B10) and (B13), i.e., procedures described above with reference to FIG. 15A.

(E11) Upon receipt of a message reporting the success of authentication, the receiving unit 62 outputs this message to the session managing unit 67. As in the case of the initial login, the session managing unit 67 processes the input message so as to update the cooperation table 72. The session managing unit 67 generates a registration request message that includes access identifier “ac002”, a third session ID, a public key of the user, and a common key. The registration request message is transmitted to the collection server 10 via the transmitting unit 63.

(E12) Upon receipt of the registration request message that includes the third session ID, the receiving unit 12 of the collection server 10 outputs this received message to the session managing unit 17. Accordingly, the session managing unit 17 first outputs the received registration request message to the signature inspecting unit 19. The signature inspecting unit 19 determines whether the registration request message includes an electronic certificate. When the signature inspecting unit 19 determines that the registration request message does not include an electronic certificate, the signature inspecting unit 19 determines that the received registration request message is a massage made in a second or later login from the terminal 80. The signature inspecting unit 19 inspects the authenticity of the public key of the user using the hash value of the common key included in the registration request message. That is, the signature inspecting unit 19 first searches the analysis ID table 23 using as a key a user ID reported by the registration request message. The signature inspecting unit 19 obtains for-inspection private information of an entry hit in the search. In particular, the for-inspection private information is a private key of the collection server 10. The signature inspecting unit 19 generates the common key using the obtained for-inspection private information and the public key of the user included in the received registration request message. The signature inspecting unit 19 calculates a hash value of the generated common key and determines whether the calculated hash value is identical with a hash value included in the registration request message. When the calculated hash value is identical with the hash value included in the registration request message, the signature inspecting unit 19 determines that the public key included in the registration request message is authentic. Then, the signature inspecting unit 19 reports to the session managing unit 17 that the authenticity of the public key has been confirmed. When the session managing unit 17 receives a report that the authenticity of the public key has been confirmed, the session managing unit 17 performs the following operations, as in the case of the initial login. That is, the session managing unit 17 searches the session management table 24 using as a key the third session ID included in the input registration request message. The session managing unit 17 registers an entry hit in the search in association with the access identifier and the public key of the user, both reported by the registration request message. When the updating of the session management table 24 is finished, the session managing unit 17 generates a registration completion message for reporting the completion of registering of the access identifier to the communication apparatus 60 and transmits this message to the communication apparatus 60 via the transmitting unit 13. The registration completion message includes the access identifier that has been registered.

Procedure (F1) is similar to the procedure (C1) described above with reference to FIG. 15B.

(F2) Upon receipt of the analysis-ID request message from the analysis server 30, the receiving unit 12 of the collection server 10 outputs the analysis-ID request message to the session managing unit 17. Accordingly, the session managing unit 17 refers to the session management table 24 so as to obtain information on an analysis ID and a public key of the user. That is, the session managing unit 17 searches the session management table 24 using an access identifier included in the analysis-ID request message as a key. The session managing unit 17 obtains an analysis ID of an entry hit in the search and information on the public key of the user. Next, the session managing unit 17 determines whether for-inspection private information is present. That is, the session managing unit 17 searches the session management table 24 using an access identifier included in the analysis-ID request message as a key. The session managing unit 17 obtains a student ID of an entry hit in the search. Next, the session managing unit 17 searches the analysis ID table 23 using the obtained student ID as a key. The session managing unit 17 determines whether for-inspection private information is stored in an entry hit in the search. Since for-inspection information is stored in the initial login, for-inspection private information has already been stored in the second or later login. Hence, in this situation, the session managing unit 17 determines that for-inspection private information has been stored. Accordingly, the session managing unit 17 transmits, to the analysis server 30, the requested analysis ID, the public key of the user, and a confirmation report indicating that the collection server 10 has confirmed the authenticity of the public key of the user.

(E14) Upon receipt of an analysis ID, a public key of the user, and a confirmation report from the collection server 10, the receiving unit 32 of the analysis server 30 outputs the received information to the access-identifier generating unit 35, the output unit 42, and the key managing unit 38. The access-identifier generating unit 35 uses the input information so as to update the analysis ID table, as in the case of the initial login. The key managing unit 38 determines whether the input information includes a confirmation report. When the key managing unit 38 determines that the input information does not include a confirmation report, the key managing unit 38 determines that the authenticity of the public key of the user has not been confirmed, and performs an error process, as in the case of the initial login. On the other hand, when the key managing unit 38 determines that the input information includes a confirmation report, the key managing unit 38 generates a common key using the input public key of the user. Specifically, the key managing unit 38 first newly generates a private key of the analysis server 30 and a public key corresponding to the private key. The key managing unit 38 generates signature information by signing the newly generated public key using an electronic certificate registered in advance. Next, the key managing unit 38 generates a common key using the generated private key and the input public key of the user. The key managing unit 38 stores the public key of the user, the public key of the analysis server 30, and the generated common key in the analysis ID table 23 in association with each other.

The output unit 42 generates and outputs, to the key managing unit 38, a packet that includes an analysis result associated with an analysis ID reported from the collection server 10. Using the generated common key, the key managing unit 38 encrypts information on the analysis result input from the output unit 42. The key managing unit 38 outputs the cryptographic data obtained through the encrypting, a public key of the analysis server 30, signature information of the public key of the analysis server 30, and an electronic certificate to the transmitting unit 33 as analysis result responses.

As a response of procedure (E13) (analysis result response), the transmitting unit 33 transmits cryptographic data, a public key of the analysis server 30, signature information of the public key of the analysis server 30, and an electronic certificate to the communication apparatus 60.

(D10) Upon receipt of an analysis result response from the analysis server 30, the receiving unit 62 of the communication apparatus 60 outputs this response to the session managing unit 67. The session managing unit 67 transmits the input analysis result response to the terminal 80 via the transmitting unit 63. To specify the terminal 80, the session managing unit 67 uses information from the cooperation table 72. A packet that includes an analysis result is transmitted to the terminal 80 as a response of procedure (D9). During procedures (D9) to (D10), the communication between the communication apparatus 60 and the terminal 80 continues using, for example, keep-alive.

Upon receipt of an analysis result response from the communication apparatus 60, the receiving unit 82 of the terminal 80 outputs this response to the signature inspecting unit 85. Accordingly, the signature inspecting unit 85 inspects a public key of the analysis server 30 using an electronic certificate and signature information included in the analysis result response.

After the inspecting, when the authenticity of the public key of the analysis server 30 is confirmed, the key managing unit 86 generates a common key using a private key of the user and the public key of the analysis server 30. The concealed-information restoring unit 83 decrypts cryptographic data included in the analysis result response using the generated common key. The concealed-information restoring unit 83 outputs the decrypted data to the application processing unit 88. The application processing unit 88 displays an analysis result on the display apparatus 89.

Next, the concealed-information restoring unit 83 determines whether decrypted cryptographic data includes for-inspection information. In this example, the concealed-information restoring unit 83 determines that the cryptographic data does not include for-inspection information.

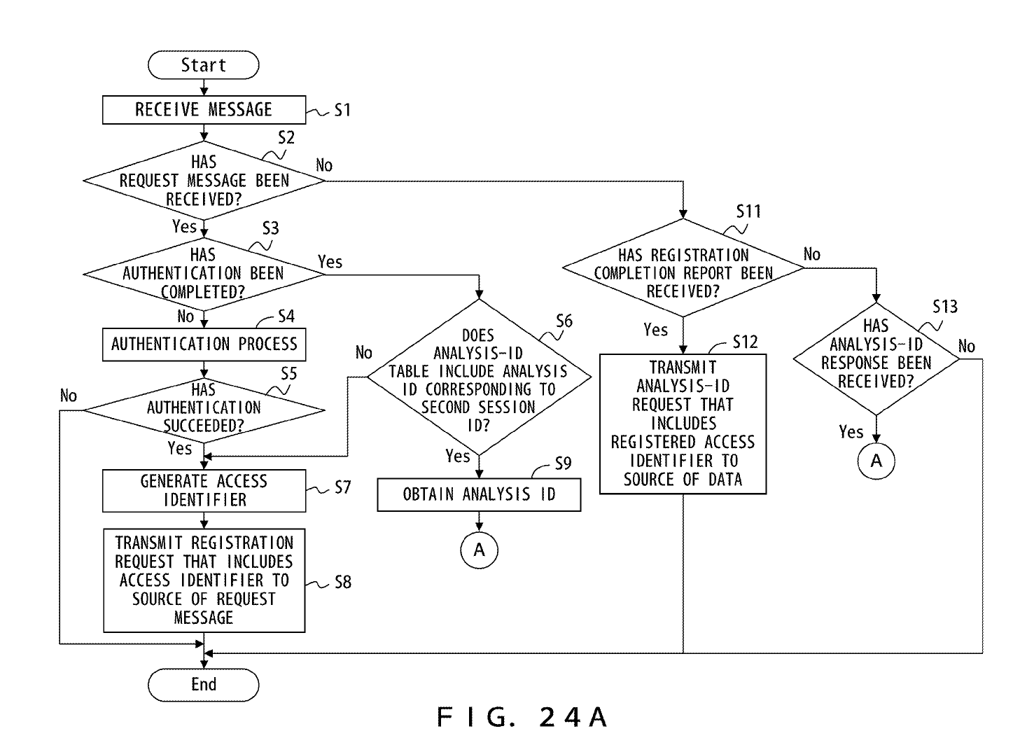

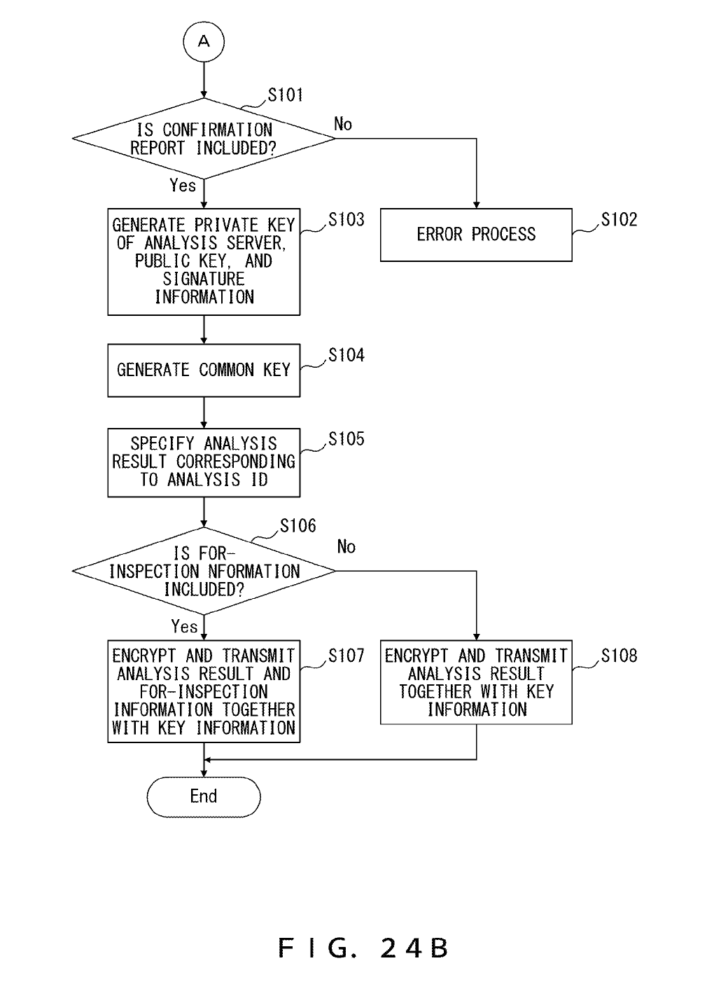

FIGS. 24A and 24B are flowcharts illustrating exemplary operations of the analysis server 30. Upon receipt of a message, the receiving unit 32 outputs this received message to the access-identifier generating unit 35 (step S1). The access-identifier generating unit 35 determines whether the input message is a request message (step S2). When the access-identifier generating unit 35 determines that a request message has been received, the access-identifier generating unit 35 determines whether authentication with a source of the request message has been finished (step S3). In one possible example, in step 3, the access-identifier generating unit 35 determines that authentication has been finished when the request message includes a second session ID, and determines that authentication has not been finished when a second session ID is not included. When the access-identifier generating unit 35 determines that authentication has not been finished, the access-identifier generating unit 35 makes a request for the authentication unit 34 to perform an authentication process, and, in response to the request, the authentication unit 34 performs authentication with a communication apparatus 60 that is the source of the request message (No in step S3; step S4). When authentication between the communication apparatus 60 and the analysis server 30 succeeds, the access-identifier generating unit 35 assigns an access identifier to the communication apparatus 60 (Yes in step S5; step S7). In addition, the access-identifier generating unit 35 records the assigned access identifier in the analysis ID table 52 in association with a second session ID associated with the communication apparatus 60. The access-identifier generating unit 35 transmits the registration request that includes the access identifier to the source of the request message via the transmitting unit 33 (step S8). For a communication apparatus that is not successfully authenticated, the access-identifier generating unit 35 terminates the process without generating an access identifier (No in step S5).

When the access-identifier generating unit 35 determines that the communication apparatus 60 that has been authenticated is the source of the service request message, the access-identifier generating unit 35 extracts the second session ID from the request message and determines whether an analysis ID is recorded in the analysis ID table 52 in association with the extracted second session ID (Yes in step S3; step S6). When the access-identifier generating unit 35 determines that an analysis ID is not recorded in the analysis ID table 52 in association with the second session ID, the access-identifier generating unit 35 performs the processes of step S7 and the following steps (No in step S6). On the other hand, when the access-identifier generating unit 35 determines that an analysis ID is recorded in the analysis ID table 52 in association with the second session ID, the access-identifier generating unit 35 obtains the analysis ID associated with the second session ID (Yes in step S6; step S9). Moreover, the access-identifier generating unit 35 outputs the obtained analysis ID to the key managing unit 38 and the output unit 42. Then, the flow shifts to step S101 in FIG. 24B.

In step S101 in FIG. 24B, the key managing unit 38 determines whether the input information includes a confirmation report (step S101). When the key managing unit 38 determines that the input information does not include a confirmation report, the key managing unit 38 determines that the authenticity of the public key of the user has not been confirmed, and performs an error process (No in step S101; step S102). On the other hand, when the key managing unit 38 determines that the input information includes a confirmation report, the key managing unit 38 newly generates a private key of the analysis server 30 and a public key corresponding to the private key (Yes in step S101; step S103). In addition to generating the public key, the key managing unit 38 generates signature information of the public key using an electronic certificate. The key managing unit 38 generates a common key using the generated private key and the input public key of the user (step S104).

The output unit 42 specifies and obtains an analysis result associated with a reported analysis ID from the storage unit 50, and outputs this analysis result to the key managing unit 38 (step S105).

The key managing unit 38 determines whether the input information includes for-inspection information (step S106). When the key managing unit 38 determines that the input information includes for-inspection information, the key managing unit 38 encrypts the for-inspection information and information on the analysis result, both input from the output unit 42, using the common key generated in step S104. The key managing unit 38 outputs the encrypted cryptographic data, the public key of the analysis server 30, signature information of the public key of the analysis server 30, and an electronic certificate to the transmitting unit 33 as analysis result responses (Yes in step S106; step S107).

On the other hand, when the key managing unit 38 determines in step S106 that input information does not include for-inspection information, the key managing unit 38 encrypts information on an analysis result input from the output unit 42 using the common key generated in step S104. The key managing unit 38 outputs the encrypted cryptographic data, the public key of the analysis server 30, signature information of the public key of the analysis server 30, and an electronic certificate to the transmitting unit 33 as analysis result responses (No in step S106; step S108).

In the meantime, when the access-identifier generating unit 35 determines in step S2 in FIG. 24A that the input message is not a request message, the access-identifier generating unit 35 determines whether a registration-completion report message has been input (step S11). When the access-identifier generating unit 35 determines that the input message is a registration-completion report message, the access-identifier generating unit 35 transmits an analysis-ID request message to the collection server 10 that is a source of data to be analyzed (Yes in step S11; step S12).

Meanwhile, when the access-identifier generating unit 35 also determines that the input message is not a registration-completion report message, the access-identifier generating unit 35 determines whether an analysis-ID response message has been input (No in step S11; step S13). When the access-identifier generating unit 35 determines that the input message is an analysis-ID response message, the access-identifier generating unit 35 extracts and reports a reported analysis ID to the key managing unit 38 and the output unit 42 (Yes in step S13). Then, the flow shifts to step S101 in FIG. 24B.

When the access-identifier generating unit 35 determines that the input message is not a request message, a registration-completion report message, or an analysis-ID response message, the access-identifier generating unit 35 terminates the process (No in step S13).

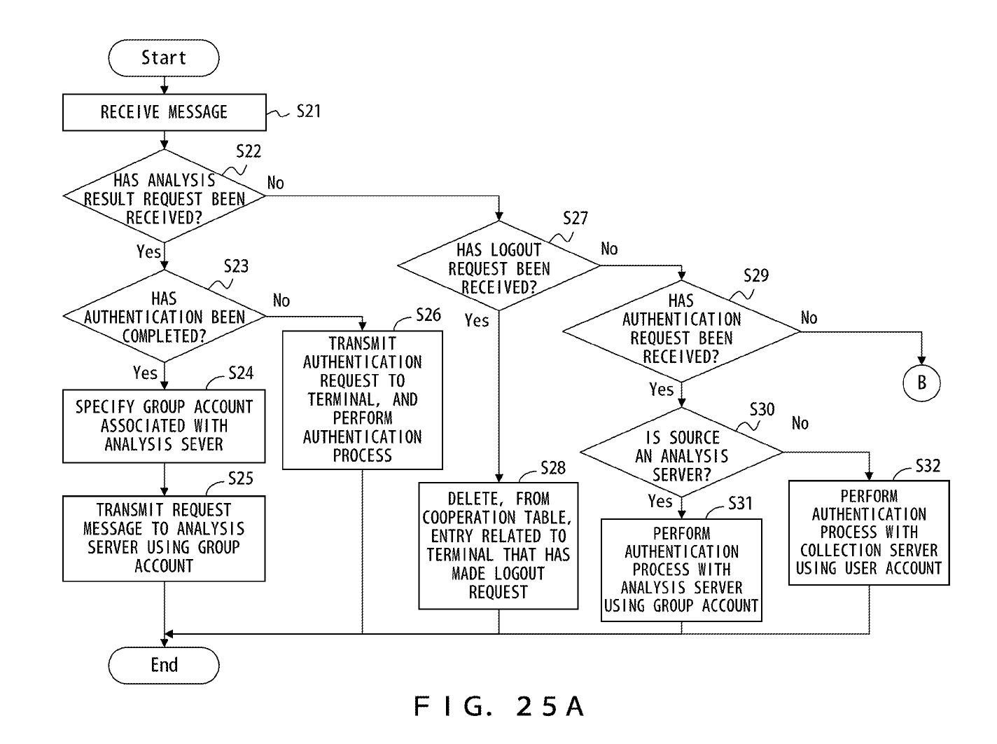

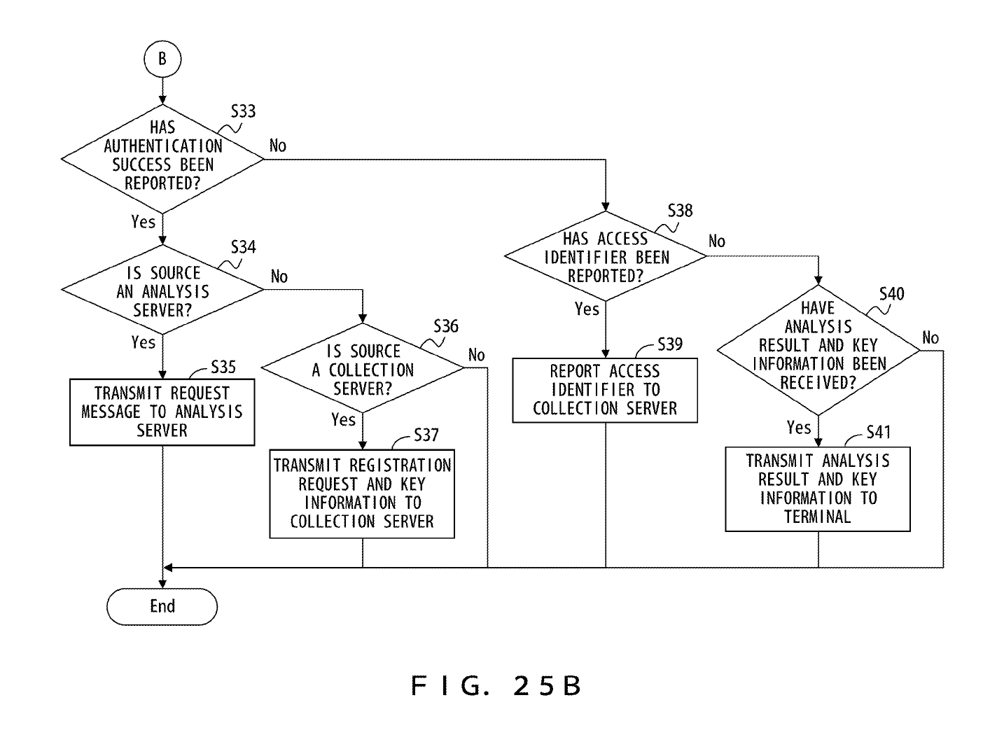

FIGS. 25A and 25B are flowcharts illustrating exemplary operations of the communication apparatus 60. The receiving unit 62 receives a message (step S21). When the receiving unit 62 determines that the received message is an analysis result request from a terminal 80, the receiving unit 62 outputs this analysis result request to the authentication unit 64 (Yes in step S22). The authentication unit 64 determines whether the analysis result request has been made by an authenticated terminal 80 (step S23). When the authentication unit 64 determines that the source of the analysis result request is an authenticated terminal 80, the authentication unit 64 outputs the analysis result request to the session managing unit 67. The session managing unit 67 stores a pubic key of the user included in the analysis result request, an electronic certificate, and a hash value of a common key, i.e., signature information, in the cooperation table 72. By referring to the ID management table 71, the session managing unit 67 specifies a group account to be used to access the analysis server 30. In this case, the session managing unit 67 searches the ID management table 71 using as keys a user ID associated with the terminal 80 and the URL of the analysis server 30 reported by the analysis result request (Yes in step S23; step S24). The session managing unit 67 uses the group account so as to generate a request message addressed to the analysis server 30, and transmits this request message to the analysis server 30 via the transmitting unit 63 (step S25). Meanwhile, when the authentication unit 64 determines in step S23 that an analysis result request has been received from a terminal 80 that has not been authenticated, the authentication unit 64 makes a request for the terminal 80 to perform authentication and performs an authentication process with the terminal 80 (step S26). In the authentication process, authentication is performed using an electronic certificate of the user.

On the other hand, when the receiving unit 62 determines that the received message is not an analysis result request, the receiving unit 62 determines whether the terminal 80 has made a request to log out the terminal 80 (No in step S22; step S27). When the receiving unit 62 determines that the terminal 80 has made a request to log out the terminal 80, the receiving unit 62 outputs the received message to the session managing unit 67 (Yes in step S27). The session managing unit 67 deletes from the cooperation table 72 an entry that includes a first session ID reported from the terminal 80 that has made a request to log out the terminal 80 (step S28).

When the receiving unit 62 determines in step S27 that the terminal 80 has not made a request to log out the terminal 80, the receiving unit 62 determines whether an authentication request has been received (step S29). When the receiving unit 62 determines that an authentication request has been received, the receiving unit 62 outputs the authentication request to the proxy authentication unit 66. The proxy authentication unit 66 determines whether the source of the authentication request is the analysis server 30 (step S30). When the proxy authentication unit 66 determines that the analysis server 30 has requested authentication, the proxy authentication unit 66 performs an authentication process with the analysis server 30 using a group account and a password associated with the group account (step S31). Meanwhile, when the proxy authentication unit 66 determines that the analysis server 30 has not requested authentication, the proxy authentication unit 66 determines that an authentication request has been received from the collection server 10. Accordingly, the proxy authentication unit 66 performs an authentication process with the collection server 10 using a user account for use in a communication with the collection server 10 and a password associated with the user account (step S32).

Meanwhile, when the receiving unit 62 determines in step S29 that an authentication request has not been reported, the receiving unit 62 shifts the flow to step S33 in FIG. 25B, where the receiving unit 62 determines whether success of authentication has been reported. When the receiving unit 62 determines that success of authentication has been reported, the receiving unit 62 outputs the received message to the session managing unit 67. The session managing unit 67 determines whether the source of the report of an authentication success is the analysis server 30 (step S34). When the session managing unit 67 determines that the source is the analysis server 30, the session managing unit 67 transmits a request message to the analysis server 30 (Yes in step S34; step S35). Meanwhile, when the session managing unit 67 determines that the source of the report of an authentication success is not the analysis server 30, the session managing unit 67 determines whether the source is the collection server 10 (No in step S34; step S36). When the session managing unit 67 determines that the source is the collection server 10, the session managing unit 67 transmits a request to register an access identifier to the collection server 10 together with a public key of the user, signature information, and an electronic certificate (Yes in step S36; step S37). Meanwhile, when the session managing unit 67 determines that the source of the report of an authentication success is neither the analysis server 30 nor the collection server 10, the session managing unit 67 terminates the process (No in step S36).

When the receiving unit 62 determines in step S33 that an authentication success has not been reported, the receiving unit 62 determines whether a report of an access identifier has been received (step S38). When the receiving unit 62 determines that a report of an access identifier has been received, the receiving unit 62 outputs the received message to the session managing unit 67. In this example, the reporting of an access identifier uses a redirect message that designates the collection server 10 as a redirect destination. The session managing unit 67 uses the redirect message so as to generate an HTTP message that is addressed to the collection server 10 and that includes the access identifier, and transmits this HTTP message via the transmitting unit 63 (Yes in step S38; step S39).

Meanwhile, when the receiving unit 62 determines in step S38 that the received message is also not a report of an access identifier, the receiving unit 62 performs the following operations. The receiving unit 62 determines whether a combination of encrypted information on an analysis result, a public key of the analysis server 30, signature information of the public key of the analysis server 30, and an electronic certificate has been received from the analysis server 30 (step S40). When the receiving unit 62 determines that a combination of encrypted information on an analysis result, a public key of the analysis server 30, signature information of the public key of the analysis server 30, and an electronic certificate has been received from the analysis server 30, the receiving unit 62 outputs the received message to the session managing unit 67. The session managing unit 67 transmits the received message via the transmitting unit 63 to the terminal 80 of the user who has transmitted an analysis result request (Yes in step S40; step S41). Then, the process ends. Meanwhile, when the receiving unit 62 determines in step S40 that a combination of encrypted information on an analysis result, a public key of the analysis server 30, signature information of the public key of the analysis server 30, and an electronic certificate has not been received from the analysis server 30, the receiving unit 62 ends the process.

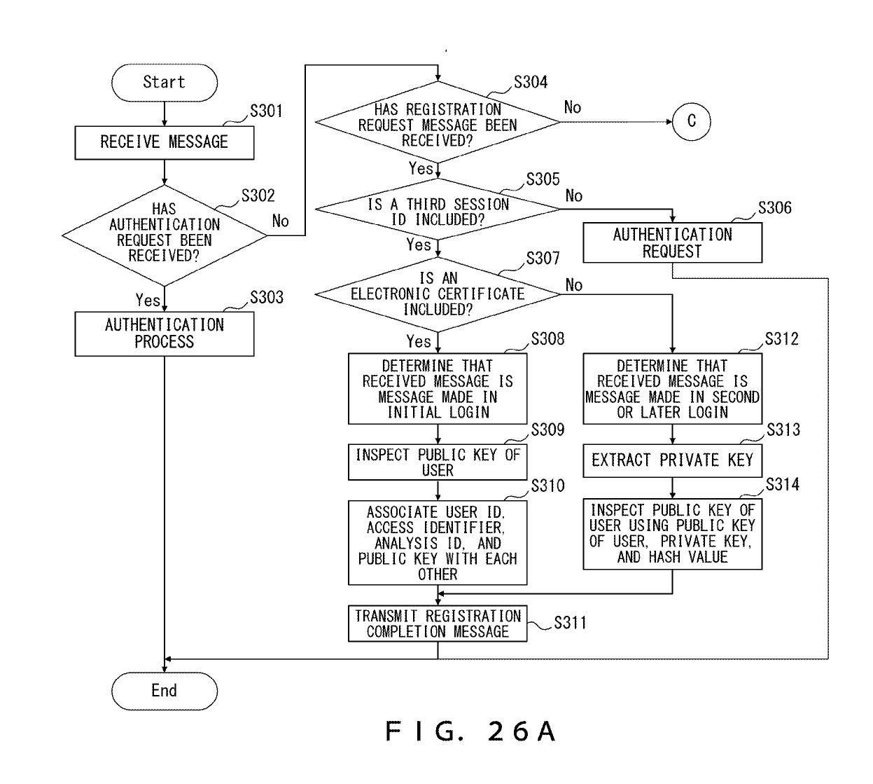

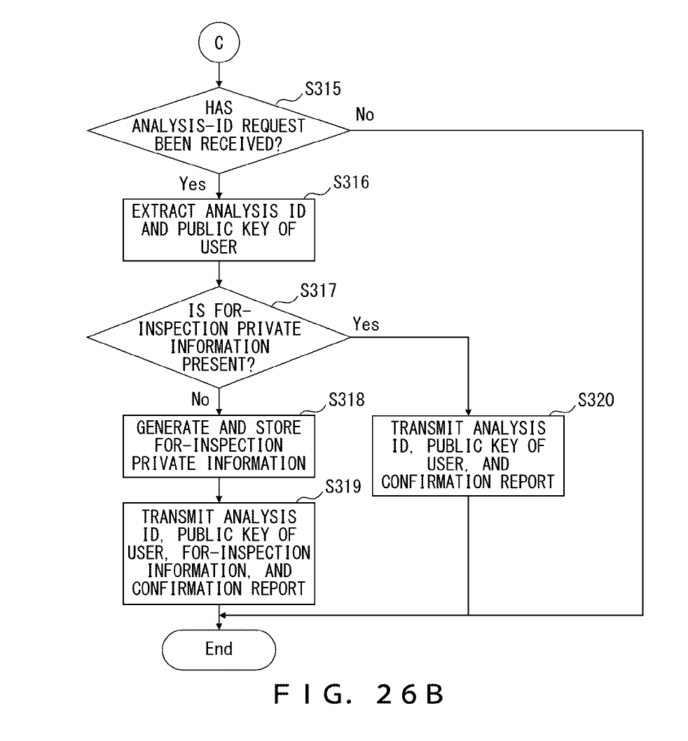

FIGS. 26A and 26B are flowcharts illustrating exemplary operations of the collection server 10.

Upon receipt of a message, the receiving unit 32 outputs the received message to the authentication unit 16 (step S301). The authentication unit 16 determines whether the input message is an authentication request (step S302). When the authentication unit 16 determines that the message is an authentication request, the authentication unit 16 performs a user-account authentication process by determining whether a user account and password included in the authentication request are identical with a prestored password and user account (step S303). When the authentication succeeds, the authentication unit 16 outputs the user account of the user for whom authentication has been newly succeeded to the session managing unit 17. The session managing unit 17 generates a third session ID for the user account reported from the authentication unit 16. The session managing unit 17 reports the success of authentication and the third session ID to the communication apparatus 60.

When the authentication unit 16 determines that the message received by the receiving unit 32 is not an authentication request, the authentication unit 16 determines whether the message is a registration request message (No in step S302; step S304). When the authentication unit 16 determines that the input message is a registration request message, the authentication unit 16 determines whether the registration request message includes a third session ID (Yes in step S304; step S305). When the authentication unit 16 determines that the registration request message does not include a third session ID, the authentication unit 16 makes a request for the source of the registration request message to perform authentication (No in step S305; step S306). Then the process ends.

When it is determined in step S305 that the registration request message includes a third session ID, the authentication unit 16 outputs the registration request message to the session managing unit 17. The session managing unit 17 outputs the registration request message to the signature inspecting unit 19. The signature inspecting unit determines whether the registration request message includes an electronic certificate (Yes step S305; step S307).

When the signature inspecting unit 19 determines that the registration request message includes an electronic certificate, the signature inspecting unit 19 determines that the received registration request message is a massage made in an initial login from the terminal 80 (Yes in step S307; step S308). The signature inspecting unit 19 inspects the authenticity of a public key using signature information of the public key and an electronic certificate (step S309). When the signature inspecting unit 19 determines that the received public key of the user is authentic, the signature inspecting unit 19 reports to the session managing unit 17 that the authenticity of the public key has been confirmed.

Upon receipt of a report that the authenticity of a public key has been confirmed, the session managing unit 17 performs the following operations. First, the session managing unit 17 searches the session management table 24 using as a key a third session ID included in the registration request message. The session managing unit 17 registers the public key and an access identifier reported by the registration request message in an entry hit in the search in association with each other (step S310). The session managing unit 17 generates a registration completion message for reporting the completion of registration of an access identifier to the communication apparatus 60, and transmits this message to the communication apparatus 60 via the transmitting unit 13 (step S311). Then the process ends.

When the signature inspecting unit 19 determines in S307 that the registration request message does not include an electronic certificate, the signature inspecting unit 19 determines that the received registration request message is a massage made in a second or later login from the terminal 80 (No in step S307; step S312). Accordingly, the signature inspecting unit 19 searches the analysis ID table 23 using as a key a user ID reported by the registration request message. The signature inspecting unit 19 obtains for-inspection private information of an entry hit in the search (step S313). Specifically, the for-inspection private information is a private key of the collection server 10. The signature inspecting unit 19 inspects a signature included in the registration request message (step S314). In particular, the signature inspecting unit 19 makes an inspection as to whether a public key is authentic using the private key of the user and the hash value, both included in the received registration request message, and the for-inspection private information obtained in S313. Then, the flow shifts to S311.

When the authentication unit 16 determines in S304 that the message received by the receiving unit 32 is not a registration request message, the authentication unit 16 outputs the message to the session managing unit 17. The session managing unit 17 determines whether the input message is an analysis-ID request message (step S315). When the session managing unit 17 determines that the input message is an analysis-ID request message, the session managing unit 17 refers to the session management table 24 so as to obtain an analysis ID and information on a public key of the user (Yes in step S315; step S316). That is, the session managing unit 17 searches the session management table 24 using as a key an access identifier included in the analysis-ID request message. The session managing unit 17 obtains an analysis ID and information on a public key from an entry hit in the search.

The session managing unit 17 determines whether for-inspection private information is present (step S317). That is, the session managing unit 17 searches the session management table 24 using as a key an access identifier included in an analysis-ID request message. The session managing unit 17 obtains a student ID from an entry hit in the search. The analysis ID table 23 is searched using the obtained student ID as a key. The session managing unit 17 determines whether for-inspection private information is stored in a hit entry.

When the session managing unit 17 determines that for-inspection private information is not present, the session managing unit 17 outputs to the key managing unit 20 a creation request report for for-inspection private information. Accordingly, the key managing unit 20 generates and stores for-inspection private information in the analysis ID table 23 in association with a student ID (No in step S317; step S318). The key managing unit 20 reports to the session managing unit 17 that the storing of for-inspection private information has been completed. The session managing unit 17 transmits a requested analysis ID, a public key of the user, for-inspection information, and a confirmation report to the analysis server 30 (S319). Then, the process ends.

When the session managing unit 17 determines in S317 that for-inspection private information is present, the session managing unit 17 reports a requested analysis ID, a pubic key of the user, and a confirmation report to the analysis server 30 (Yes in S317; S318). Then, the process ends.

When the session managing unit 17 determines in S315 that the receiving unit 32 has not received an analysis-ID request, the process ends (No in S315).

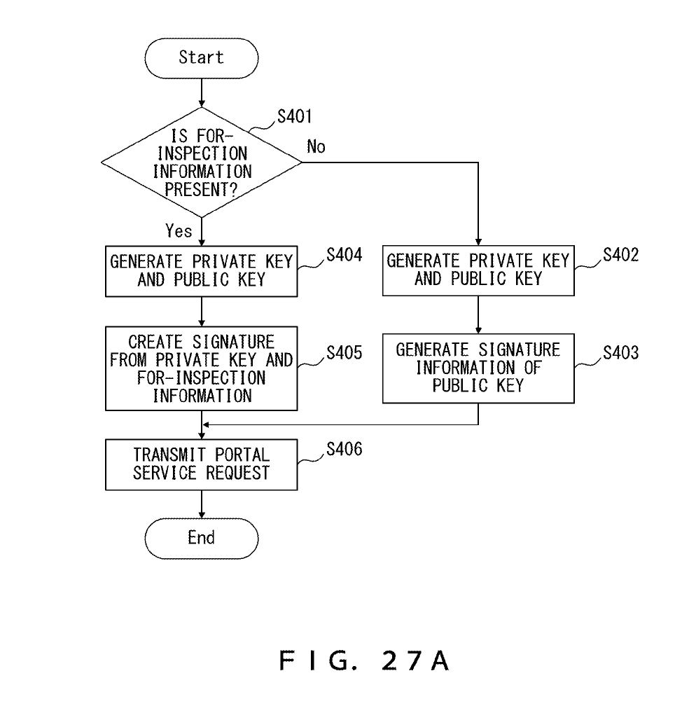

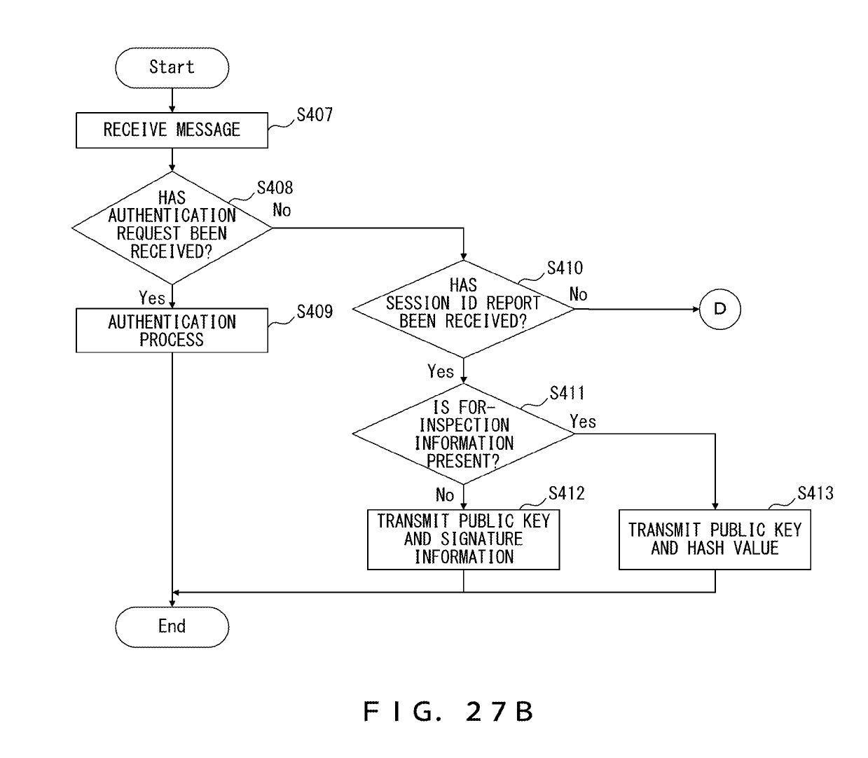

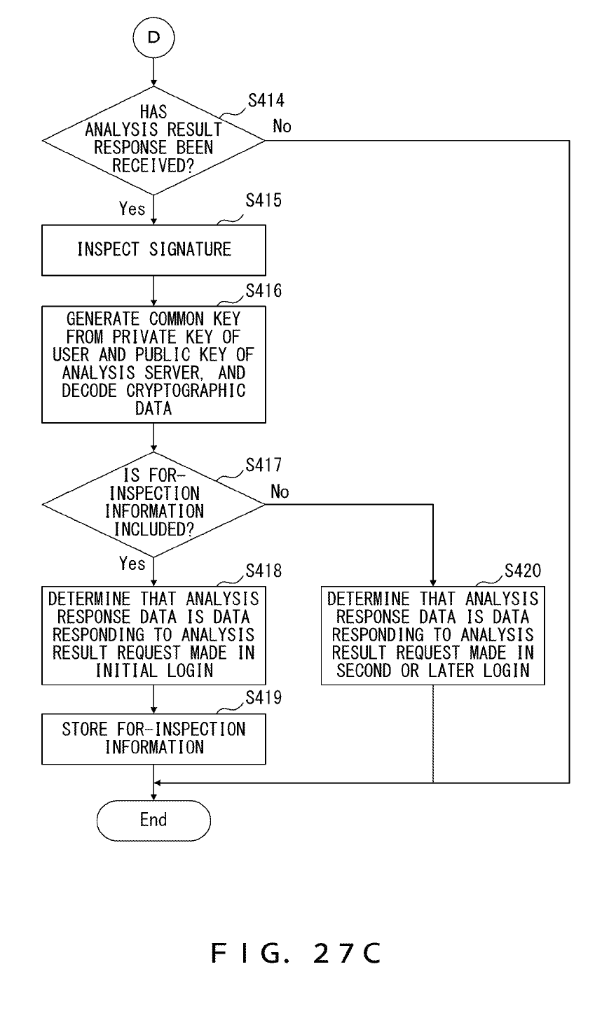

FIGS. 27A, 27B, and 27C are flowcharts illustrating exemplary operations of the terminal 80.

Referring to FIG. 27A, the key managing unit 86 first determines whether for-inspection information 93 is stored in the storage unit 91 (step S401). When the key managing unit 86 determines that for-inspection information 93 is not stored in the storage unit 91, the key managing unit 86 generates a private key of the user and a public key corresponding to the private key (No in step S401; step S402). The signature creating unit 87 generates signature information of the public key (step S403). When the signature creating unit 87 obtains an electronic certificate, the signature creating unit 87 records the private key and public key of the user generated in S402, the signature information generated in S403, and the electronic certificate in the key management table 92 in association with each other. Then, the flow shifts to step S406.

When the key managing unit 86 determines in step S401 that for-inspection information 93 is stored in the storage unit 91, the key managing unit 86 generates a private key different from a private key used in a previously performed process of requesting an analysis result, and a public key corresponding to the generated private key (Yes in step S401; S404). The signature creating unit 87 generates a common key (signature) using for-inspection information 93 and the private key generated by the key managing unit 86 (step S405). After generating the common key, the signature creating unit 87 records the private key and public key of the user generated in S404 and the common key (common key of the collection server 10 and the user) in the key management table 92 in association with each other.

The application processing unit 88 transmits a portal service request to the communication apparatus 60 (S406). Then, the process temporarily ends.

Referring to FIG. 27B, upon receipt of a message, the receiving unit 82 outputs the received message to the application processing unit 88 (step S407). Accordingly, the application processing unit 88 determines whether the input message is an authentication request (step S408). When the application processing unit 88 determines that the input message is an authentication request, the application processing unit 88 performs an authentication process for access to the communication apparatus 60 (Yes in step S408; step S409). In the authentication process, the application processing unit 88 obtains an electronic certificate of the user from the key management table 92, and transmits the electronic certificate to the communication apparatus 60. Various authentication methods may be used for the authentication process.

When the application processing unit 88 determines in step S408 that the input message is not an authentication request, the session managing unit 84 determines whether the message is a report of a first session ID (No in step S408; step S410). When the session managing unit 84 determines that the message is a report of a first session ID, the session managing unit 84 determines whether for-inspection information is recorded in the storage unit 91 (Yes in step S410; step S411). When the session managing unit 84 determines that for-inspection information is not recorded, the session managing unit 84 transmits the public key of the user and signature information as an analysis result request (No in step S411; S412). In a case where an electronic-certificate-based authentication method is not used in the authentication process in step S409, the public key of the user, signature information, and the electronic certificate are incorporated into the analysis result request.

When the session managing unit 84 determines in step S411 that for-inspection information is recorded, the session managing unit 84 obtains the signature (common key) generated in S405, i.e., a signature of a public key, from the key management table 92. The signature creating unit 87 calculates a hash value of the common key using a predetermined hash function. The session managing unit 84 transmits the hash value of the common key to the communication apparatus 60 together with the public key (Yes in step S411; S413).

When the session managing unit 84 determines in step S410 that the input message is not a report of a first session ID, the receiving unit 82 outputs the received message to the signature inspecting unit 85. Accordingly, the signature inspecting unit 85 determines whether the received message is an analysis result response (No in step S410; step S414). When the signature inspecting unit 19 determines that an analysis result response has been received, the signature inspecting unit 19 inspects a signature of a public key of the analysis server 30 using an electronic certificate and signature information included in the analysis result response (Yes in step S414; step S415).

After the inspecting, when the authenticity of the public key of the analysis server 30 is confirmed, the key managing unit 86 generates a common key using the public key of the analysis server 30 and a private key of the user. The key managing unit 86 records the generated common key (common key of the analysis server and the user), the public key of the analysis server 30, and the private key of the user in the key management table 92 in association with each other. Using the common key, the concealed-information restoring unit 83 decrypts cryptographic data received from the analysis server 30 (step S416). The concealed-information restoring unit 83 outputs the decrypted data to the application processing unit 88. The application processing unit 88 displays an analysis result on the display apparatus 89.

The concealed-information restoring unit 83 determines whether decrypted cryptographic data includes for-inspection information (step S417). When the concealed-information restoring unit 83 determines that the cryptographic data includes for-inspection information, the concealed-information restoring unit 83 determines that received analysis response data is data responding to an analysis result request made in an initial login (Yes in step S417; step S418). The concealed-information restoring unit 83 records the for-inspection information included in the cryptographic data in for-inspection information 93 in the storage unit 91 (step S419). Then, the process ends.

When the concealed-information restoring unit 83 determines in step S417 that the cryptographic data does not include for-inspection information, the concealed-information restoring unit 83 determines that the received analysis response data is data responding to an analysis result request made in a second or later login (No in step S417; step S420). Then, the process ends. In step S414, the process ends when the signature inspecting unit 85 determines that the input data is not an analysis result response (No in S414).

### VARIATION

A group identifier may be arbitrary information that allows the analysis server 30 to uniquely identify a group. For example, a group account, a session ID issued for authentication with the group account, and so on may be used as group identifiers. Similarly, a user identifier may be arbitrary information that allows the collection server 10 to uniquely identify a user. For example, a user account, a session ID issued for authentication with the user account, and so on may be used as personal identifiers.

The descriptions above have been given for an exemplarity situation in which a network includes one terminal 80, one communication apparatus 60, one collection server 10, and one analysis server 30, but the network may include any number of terminals 80, communication apparatuses 60, collection servers 10, and analysis servers 30. In a case where there are a plurality of analysis servers 30, an access destination is reported from the terminal 80 to the communication apparatus 60 when the communication apparatus 60 attempts to access an analysis server 30, so that the communication apparatus 60 can specify the access destination. In a case where there are a plurality of collection servers 10, the communication apparatus 60 uses information such as a URL reported from the analysis server 30 when the communication apparatus 60 attempts to access a collection server 10, so that the communication apparatus 60 can specify the collection server 10, i.e., an access destination. In the case of a network that includes a plurality of collection servers 10 and a plurality of analysis servers 30, the communication apparatus 60 uses the ID management table 71 so as to specify an account and password to be used to gain access. In addition, when a plurality of terminals 80 are present, individual users may be distinguished using, for example, first to third session IDs or access identifiers, thereby allowing the collection server 10, the analysis server 30, and the communication apparatus 60 to process requests from a plurality of users in parallel.

The tables used in the descriptions above are examples, and hence information elements included in the tables may be changed in accordance with an implementation. For simplicity of description, an exemplary situation was described in which the communication apparatus 60, the collection server 30, and the analysis server 30 are each one server. However, for example, the design may be changed to achieve operations of the communication apparatus 60 using a plurality of arbitrary communication apparatuses 60. Similarly, processes that would be performed by the collection server 10 and the analysis server 30 may be achieved by a plurality of communication apparatuses 60.

For example, the inspection of the authenticity of a received public key in procedure (6) and procedure (14) in FIG. 2 and procedure (14) in FIG. 3, i.e., an inspection made using an electronic signature and an electronic certificate, may be made in the following manner. For description, assume that a public key X is a public key whose authenticity is ensured by the issuer of an electronic certificate (a public key included in the electronic certificate) and that a private key Y, which is a private key of a transmission-side terminal, corresponds to the public key X. In one possible example, a transmission-side apparatus calculates a hash value using a predetermined hash algorithm H, generates an electronic certificate for the calculated hash value using the private key Y, and transmits the electronic certificate to a reception-side terminal together with a public key to be inspected. Upon receipt of the data, the reception-side terminal obtains a hash value h1 by decrypting the received electronic certificate using the public key X. Using the predetermined hash algorithm H, the reception-side terminal calculates a hash value h2 for the received public key to be inspected. The reception-side terminal compares the hash value h1, i.e., a value obtained via the decrypting, with the hash value h2, i.e., a calculated value, and determines whether these values are identical with each other. When these values are identical with each other, the reception-side terminal determines that the received public key to be inspected is authentic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for a key transmission, the method comprising:
transmitting, by a user terminal, a first public key of the user terminal, an electronic signature for the first public key, and an electronic certificate electronically signing the first public key to a first information processing apparatus via a communication apparatus that communicates with the first information processing apparatus, a second information processing apparatus, and the user terminal; and
transmitting, by the first information processing apparatus, the first public key to the second information processing apparatus via a route that does not link to the communication apparatus when the first information processing apparatus determines that the first public key is authentic using the electronic signature and the electronic certificate.

2. The method according to claim 1, further comprising:
transmitting, by the second information processing apparatus, a second public key of the second information processing apparatus to the user terminal via the communication apparatus.

3. The method according to claim 2, wherein;
when the first information processing apparatus determines that the first public key is authentic, the first information processing apparatus transmits a third public key of the first information processing apparatus, together with the first public key, to the second information processing apparatus via a route that does not link to the communication apparatus; and
the second information processing apparatus encrypts the received third public key using a first common key generated from the received first public key and a second private key corresponding to the second public key, and transmits the second public key and the encrypted third public key to the user terminal via the communication apparatus.

4. The method according to claim 3, wherein:
the user terminal generates a second common key from the third public key received from the second information processing apparatus and a fourth private key of the user terminal, and transmits the generated second common key and a fourth public key corresponding to the fourth private key to the first information processing apparatus via the communication apparatus; and
the first information processing apparatus inspects authenticity of the fourth public key using the received fourth public key and a third private key corresponding to the third public key.

5. The method according to claim 2, wherein:
the first public key is associated with first identification information for identification of a user;
the user terminal transmits the first identification information to the first information processing apparatus via the communication apparatus;
when the first information processing apparatus determines that the first public key is authentic, the first information processing apparatus transmits, to the second information processing apparatus, second identification information stored by the first information processing apparatus and associated with the first identification information; and
the second information processing apparatus uses the first common key to encrypt information stored by the second information processing apparatus and associated with the second identification information, and transmits the encrypted information to the user terminal via the communication apparatus.

6. The method according to claim 5, wherein:
upon receipt of a transmission request for information from the user terminal via the communication apparatus, the second information processing apparatus transmits third identification information for identification of the transmission request to the communication apparatus; and
upon receipt of information obtained by associating the first identification information and the third identification information with each other from the communication apparatus, the first information processing apparatus transmits the second identification information associated with the first identification information to the second information processing apparatus.

7. The method according to claim 2, wherein:
when the first information processing apparatus determines that the first public key is authentic, the first information processing apparatus transmits inspection information to the second information processing apparatus via a route that does not link to the communication apparatus, the inspection information indicating that the first information processing apparatus has confirmed that the first public key is authentic; and
upon receipt of the inspection information, the second information processing apparatus transmits the second public key to the user terminal via the communication apparatus.

8. A key transmitting system comprising:
a first information processing apparatus;
a second information processing apparatus;
a user terminal; and
a communication apparatus that communicates with the first information processing apparatus, the second information processing apparatus, and the user terminal, wherein:
the user terminal includes a computer which includes a processor that performs a user terminal transmitting process that transmits a first public key of the user terminal, an electronic signature for the first public key, and an electronic certificate electronically signing the first public key to the first information processing apparatus via the communication apparatus; and
the first information processing apparatus includes a computer which includes a processor that performs a process including:
an inspecting process that inspects authenticity of the first public key using the electronic signature and the electronic certificate; and
a first-information-processing-apparatus transmitting process that transmits the first public key to the second information processing apparatus via a route that does not link to the communication apparatus when the inspecting process determines that the first public key is authentic.

9. The system according to claim 8, wherein
the second information processing apparatus includes a computer which includes a processor that performs a second-information-processing-apparatus transmitting process that transmits a second public key of the second information processing apparatus to the user terminal via the communication apparatus.

10. The system according to claim 9, wherein:
when the first information processing apparatus determines that the first public key is authentic, the first-information-processing-apparatus transmitting process transmits a third public key of the first information processing apparatus, together with the first public key, to the second information processing apparatus via a route that does not link to the communication apparatus;
the second information processing apparatus encrypts the received third public key using a first common key generated from the received first public key and a second private key corresponding to the second public key; and
the second-information-processing-apparatus transmitting process transmits the second public key and the encrypted third public key to the user terminal via the communication apparatus.

11. The system according to claim 10, wherein:
the processor included in the computer included in the user terminal further performs a key managing process that generates a second common key from the third public key received from the second information processing apparatus and a fourth private key of the user terminal;
the user-terminal transmitting process transmits the generated second common key and the a fourth public key corresponding to the fourth private key to the first information processing apparatus via the communication apparatus; and
the inspecting process performed at the first information processing apparatus further inspects authenticity of the fourth public key using the received fourth public key and a third private key corresponding to the third public key.

12. The system according to claim 9, wherein:
the first public key is associated with first identification information for identification of a user;
the user-terminal transmitting process further transmits the first identification information to the first information processing apparatus via the communication apparatus;
when the inspecting process determines that the first public key is authentic, the first-information-processing-apparatus transmitting process further transmits, to the second information processing apparatus, second identification information stored in a memory included in the first information processing apparatus and associated with the first identification information;
the second information processing apparatus uses the first common key to encrypt information stored in a memory included in the second information processing apparatus and associated with the second identification information; and
the second-information-processing-apparatus transmitting process transmits the encrypted information to the user terminal via the communication apparatus.

13. The system according to claim 12, wherein:
upon receipt of a transmission request for information from the user terminal via the communication apparatus, the second-information-processing-apparatus transmitting process transmits third identification information for identification of the transmission request to the communication apparatus; and
when the first information processing apparatus receives information obtained by associating the first identification information and the third identification information with each other from the communication apparatus, the first-information-processing-apparatus transmitting process transmits the second identification information associated with the first identification information to the second information processing apparatus.

14. The system according to claim 9, wherein:
when the inspecting process performed at the first information processing apparatus determines that the first public key is authentic, the first-information-processing-apparatus transmitting process transmits inspection information to the second information processing apparatus via a route that does not link to the communication apparatus, the inspection information indicating that the first information processing apparatus has confirmed that the first public key is authentic; and
when the second information processing apparatus receives the inspection information, the second-information-processing-apparatus transmitting process transmits the second public key to the user terminal via the communication apparatus.

15. A non-transitory computer-readable recording medium having stored therein a program for causing a computer to execute a process for controlling a key transmission, the process comprising:
receiving, from a user terminal, a first public key of the user terminal, an electronic signature for the first public key, and an electronic certificate electronically signing the first public key via a communication apparatus that communicates with the computer, an information processing apparatus, and the user terminal;
determining whether the first public key is authentic using the electronic signature and the electronic certificate; and
transmitting the first public key to the information processing apparatus via a route that does not link to the communication apparatus when determining that the first public key is authentic.
